(19) United States
(12) Patent Application Publication
(10) Pub. No.: US 2023/0042058 A1
(43) Pub. Date: Feb. 9, 2023

(54) SMART-LOCK SYSTEM AND METHOD OF OPERATING THE SMART-LOCK SYSTEM

(71) Applicant: Pattern Orville Dodo N'Guessan, South Croydon (GB)

(72) Inventor: Pattern Orville Dodo N'Guessan, South Croydon (GB)

(21) Appl. No.: 17/968,654

(22) Filed: Oct. 18, 2022

Related U.S. Application Data
(60) Provisional application No. 63/256,638, filed on Oct. 18, 2021.

(51) Int. Cl. G07C 9/00; G01J 1/42

(52) U.S. Cl. CPC G07C 9/00904; G01J 1/4204; G07C 9/00571

(57) ABSTRACT

A smart-lock system and a method of operating the system is disclosed. The system comprises a smart-lock on a door of a room. The door comprises a first and a second side. The first side of the door lies on the interior side of the room and the second side of the door lies on the exterior side of the room. At least one sensor is disposed on the first side of the door to detect the presence of any user on the interior side of the room and at least one sensor is disposed on the second side of the door to detect the presence of any user at the exterior side of the room. The smart-lock is configured to lock the room when the room is occupied.

### RELATED APPLICATIONS

This application claims the benefit of the U.S. provisional application 63/256,638 titled “INNOVATIVE SMART-LOCK FOR DOORS” by Pattern Orville Dodo N'Guessan filed on Oct. 18, 2021. This provisional patent application s incorporated herein by reference.

### FIELD OF INVENTION

The present invention generally relates to electronic devices, and, more particularly, to a smart-lock system and a method of operating the smart-lock system.

### BACKGROUND

Generally, buildings such as apartment houses, dormitories, hotels, or the like, which have multiple interior private areas or rooms such as bedrooms, bathrooms, shower-rooms, and toilets have a door with a latch. The latch is operable on both sides of the door. Many-a-times, when a user enters a private room (such as a bathroom), the user forgets to use the latch to lock the room. In such scenario, another user entering the same room (which had not been locked earlier by the user who first entered the room) may not be desirable. In one conventional solution, a mechanical display is provided on the door that displays whether the room is occupied or vacant. However, such solution still requires the user to lock the door of the room before the mechanical display correctly shows that the room is occupied. Thus, should the user forget to lock the door of the room, the mechanical display would not fulfil its purpose of indicating that the room has become occupied. Since current mechanical displays are based on a conventional latching mechanism, the privacy of the user could be greatly compromised should he/she forget to apply the door latch after entering a room in which he/she wishes to have privacy.

In light of the foregoing, there exists a need for a technical and reliable solution that would solve the above-mentioned problems.

### SUMMARY

In an embodiment, the smart-lock may have two sides—an interior side and an exterior side. Throughout this document, when discussing the “interior side” of the smart-lock, it is in reference to the side of the smart-lock that a user may be facing when the user is operating the smart-lock (through physical contact/handling) from inside (i.e., from inside the room whose door(s) has the smart-lock installed or fitted onto it). Similarly, when discussing the “exterior side” of the smart-lock, it is in reference to the side of the smart-lock that a user may be facing when the user is operating the smart-lock (through physical contact/handling) from outside (i.e., from outside the room whose door(s) has the smart-lock installed or fitted onto it).

In an embodiment, the smart-lock can include a Light Dependent Resistor (LDR) sensor on its exterior side. The exterior LDR sensor can be used to measure the luminance or the level of brightness of the area surrounding the exterior side of the smart-lock. In an embodiment, the smart-lock can include a Light Dependent Resistor (LDR) sensor on its interior side. The interior LDR sensor can be used to measure the luminance or the level of brightness inside the room whose door has the smart-lock installed/fitted on it.

In an embodiment, the smart-lock can include a Passive Infrared (PIR) sensor on its interior side. The interior PIR sensor can be used by the smart-lock to detect the presence of any user inside the room, and thus determine the occupancy status (i.e., occupied or vacant) of the room. In an embodiment, the smart-lock can include an alternative or additional means (such as an ultrasound device or a microphone device) of detecting the occupancy status of the room.

In an embodiment, the smart-lock can include a Passive Infrared (PIR) sensor on its exterior side. The exterior PIR sensor can be used in a process called “virtual knock”. Virtual knock can be defined as the process or action of the smart-lock notifying or alerting the user of the occupancy status of the room as the user steps near (or in front of) the door of the room.

In an embodiment, the smart-lock can include (on its exterior side) a display as a means of displaying the occupancy status of the room (i.e., display whether the room is vacant or occupied), This display (i.e., the exterior display) can be included on the exterior side of the smart-lock such that the exterior display may be visible on the exterior side of the smart-lock. Should the door (unto which the smart-lock has been installed) be closed—the exterior display would be visible from outside the room.

In an embodiment, the smart-lock can include (on its interior side) a display as a means of displaying its lock status (i.e., display whether the locks of the smart-lock are applied or retracted). This display (i.e., the interior display) can be included on the interior side of the smart-lock such that the interior display may be visible on the interior side of the smart-lock. Should the door (unto which the smart-lock has been installed) be closed—the interior display would be visible from inside the room.

In an embodiment, the smart-lock can be configured to also function as an intelligent controlling device; the smart-lock can include a communication device which can be configured to communicate with other smart devices (such as a smart light bulb, a smart light switch, a smart power switch, and the like) and control/operate these smart devices accordingly. In an embodiment, the smart-lock can be configured to operate smart devices based on the occupancy status of the room.

In an embodiment, the smart-lock can be configured to operate a child safety lock mode which is dubbed “safe opening” in this document. This is further discussed in the section of this document entitled “Safe opening”.

In an embodiment, the smart-lock can also be configured to grant access to a room based on different factors such as the identity of the person who is attempting to access the room—this mode of operation is referred to as “conditional access” in this document. This is further discussed in the section of this document entitled “Conditional access”.

These and other features and advantages of the smart-lock will become apparent from the detailed description below, in light of the accompanying drawings.

### BRIEF DESCRIPTION OF THE ACCOMPANYING DRAWINGS

The novel features which are believed to be characteristic of the smart-lock, as to its structure, organization, use and method of operation, together with further objectives and advantages thereof, will be better understood from the following drawings in which a presently preferred embodiment of the smart-lock will be illustrated by way of various examples. It is expressly understood, however, that the drawings are for the purpose of illustration and description only and are not intended as a definition of the limits of the inventions (such as features, methods, processes, devices, and systems) disclosed in this document. The examples given in this specification are not intended to limit the scope of the inventions disclosed in this document. Embodiments of the smart-lock will now be described by way of examples in association with the accompanying drawings in which:

FIG. 1 shows a top perspective view of an environment of a smart-lock system, in accordance with an embodiment of the invention;

FIG. 2 shows aside view of an environment of a smart-lock system, in accordance with an embodiment of the invention:

FIG. 3 shows various components included on the interior side of a smart-lock of the system of FIG. 1;

FIG. 4 shows various components included on the exterior side of the smart-lock of the system of FIG. 1:

FIG. 5 shows various components included on the “virtual knocker” which is a device that can offer an alternative (i.e., alternative to a smart-lock) means of displaying the occupancy status of a room, in accordance with an embodiment of the present invention;

FIG. 6 shows various components included on the “wireless remote” which can be a companion device for a smart-lock, in accordance with an embodiment of the present invention;

FIG. 7 shows a flowchart of a method by which an administrator can create a conditional access rule, in accordance with an embodiment of the present invention;

FIG. 8 shows a side view of the biometric door handle mounted on a door, in accordance with an embodiment of the present invention;

FIG. 9 shows an imaging sensor provided on the top side of the biometric door handle, in accordance with an embodiment of the present invention;

FIG. 10 shows a side view of the door handle, in accordance with an embodiment of the present invention;

FIG. 11 shows the exterior side of the smart-lock having a solar panel, in accordance with an embodiment of the present invention;

FIG. 12 shows a front view of the door handle that allows for mounting on both left-handed and right-handed doors, in accordance with an embodiment of the present invention;

FIG. 13 shows yet another side view of the door handle mounted onto the door, in accordance with an embodiment of the present invention;

FIG. 14 shows the surface of side A of the door handle, in accordance with an embodiment of the present invention;

FIG. 15 shows the surface of side 8 of the door handle, in accordance with an embodiment of the present invention;

FIG. 16 shows different embodiments of segment displays, in accordance with an embodiment of the present invention;

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to clearly teach about the smart-lock and the various innovations (such as features, methods, processes, devices, and systems) that can be included in an intelligent locking system. There may be additional components described in the foregoing application that are not depicted on one of the described drawings. In the event such a component is described, but not depicted in a drawing, the absence of such a drawing should not be considered as an omission of such design from the specification.

Before describing the proposed smart-lock in detail, it should be observed that the smart-lock comprises various components. Accordingly, components have been represented, showing only specific details that are pertinent for understanding the smart-lock so as not to obscure the disclosure with details that will be readily apparent to those with ordinary skill in the art having the benefit of the description herein. As required, detailed embodiments of the smart-lock are disclosed herein; however, it is to be understood that the disclosed embodiments are merely examples of the smart-lock. The smart-lock can be embodied in various forms with any combination of the innovative features disclosed herein. Therefore, specific structural and functional details disclosed herein are not to be interpreted as limiting, but merely as a basis for the claims and as a representative basis for teaching one skilled in the art to variously employ the smart-lock in virtually any appropriately detailed structure. Furthermore, the terms and phrases used herein are not intended to be limiting but are rather used to provide an understandable description of all innovations disclosed in this document.

References to “one embodiment”, “an embodiment” “another embodiment”, “yet another embodiment”. “one example”. “an example”, “another example”, “yet another example”, and so on, indicate that the embodiment(s) or example(s) so described may include a particular feature, structure, characteristic, property, or element, but that not every embodiment or example necessarily includes that particular feature, structure, characteristic, property, or element. Furthermore, repeated use of the phrase “in an embodiment” does not necessarily refer to the same embodiment.

Furthermore, uses of the phrase “second user” refers to a user who is outside the room whose door has the proposed smart-lock installed/fitted unto it. Whilst uses of the phrase “first user” refers to a user who is inside the room whose door has the proposed smart-lock installed/fitted unto it.

Discussions and examples regarding the lock status of the smart-lock generally assume that the smart-lock is the only lock installed/fitted on the door of the room discussed. When the door of a room (which has the smart-lock installed/fitted onto it) is said to be unlocked, or a room (whose door has the smart-lock installed unto it) is said to be unlocked—it means that the locks of the smart-lock are retracted (i.e., the locks of the smart-lock are not applied). When the door of a room (which has the smart-lock installed/fitted onto it) is said to be locked, or a room (whose door has the smart-lock installed unto it) is said to be locked—it means that the locks of the smart-lock are applied. The lock status of the smart-lock can be “locked” or “ready” (the lock status “ready” is later discussed in the section of this document entitled “Safe opening”) whilst the locks of the smart-lock are applied.

Throughout this document, when the locks of the smart-lock are said to be “retracted”—it means that the locks of the smart-lock are not applied (i.e., the lock status of the smart-lock is “unlocked”). Various forms of the word “retracted” (such as “retract” and “retracting”) are used. The act of retracting the locks of the smart-lock means causing the locks of the smart-lock to be unapplied and the lock status of the smart-lock to become “unlocked”. Whilst the locks of the smart-lock are applied (with the door unto which the smart-lock is installed being closed), turning any door handle that may comprise the exterior side of the smart-lock (or any attempt to open the door unto which the smart-lock is installed) would not allow the door of the room (whose door has the smart-lock installed onto it) to open—this is as controlled by the locking-unlocking device that is comprising the smart-lock. To enable a user who is outside the room (whose door has the smart-lock installed onto it) to open the door of the room—the locks of the smart-lock would need to be retracted. Whilst the lock status of the smart-lock is “unlocked”, a user who is outside the room (whose door has the smart-lock installed onto it) may open the door unto which the smart-lock has been fitted this could for example be by the said user turning any door handle (or doorknob, or performing an action to cause the door to open) that may be comprising the exterior side of the smart-lock.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

The phrase “such as” is used to give one or more examples and should not be interpreted as limiting. The phrase “such as” can generally be understood to mean “such as, for example”.

In examples used in this document, the smart-lock is sometimes said to be connected to be a device/system—it entails that the smart-lock can be configured to connect to the said device/system. In examples used in this document, the smart-lock is sometimes said to be connected to a device/system in order to highlight/illustrate a feature/function of the said device/system or a feature/function of the smart-lock or both. It should be noted that although the smart-lock can be configured to connect to (and communicate with) other devices and systems; the smart-lock can function on its own.

The term “purpose” is generally used to provide examples of use-cases and applications and should not be interpreted as limiting.

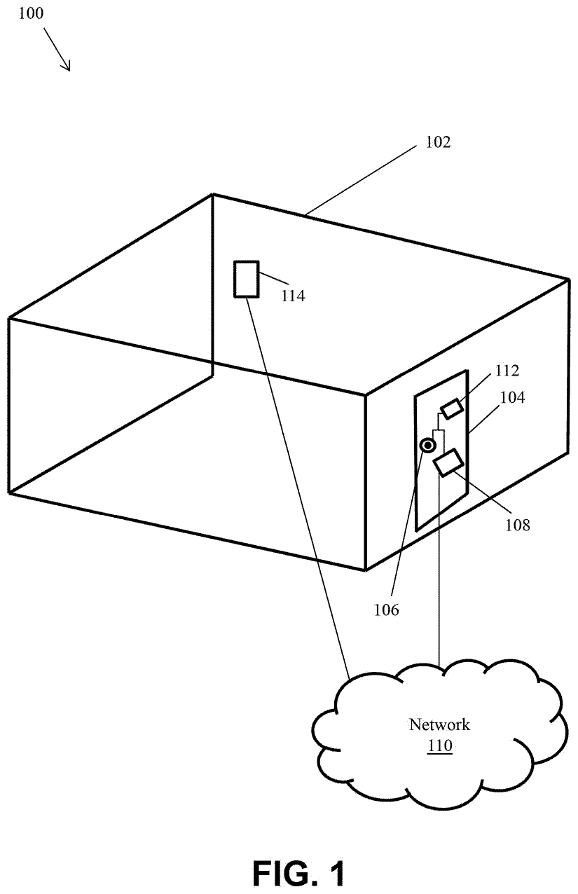

The terms “interior” and “exterior” are used throughout this document in discussing various embodiments of the smart-lock. The term “interior” is generally used to describe an item/component/part that would be inside the room (i.e., the room shown in the system on FIG. 1) when the door unto which the smart-lock is installed/fitted is closed. The term “exterior” is generally used to describe an item/component/pan that would be outside the room (i.e., the room shown in the system on FIG. 1) when the door unto which the smart-lock is installed/fitted is closed. In examples and embodiments of the smart-lock discussed, whilst certain components are said to be included on the interior side of the smart-lock, it should be noted that (in some other embodiments of the smart-lock) some components may instead be included on the exterior side of the smart-lock or another part of the smart-lock—this is as long as a given component can still achieve its purpose when included on a different side of the smart-lock. Similarly. In examples and embodiments of the smart-lock discussed, whilst certain components are said to be included on the exterior side of the smart-lock, it should be noted that (in some other embodiments of the smart-lock) some components may instead be included on the interior side of the smart-lock or another part of the smart-lock. For example, technologies that can be included on the interior side of the smart-lock for the purpose of detecting a presence inside the room (i.e., the room whose door has the smart-lock installed/fitted unto it) can also be included on the exterior side of the smart-lock for the purpose of detecting a presence outside the room, and vice-versa.

The room shown in the system is used throughout this document to describe several applications and use-cases for the smart-lock in accordance with different embodiments of the smart-lock. However, the room (i.e., the room shown in the system on FIG. 1) can in practice be any room—the room can also represent any structure/place whose door/doors is secured by (or can be secured by) the proposed smart-lock. Examples of structures and places that the room can represent include and is not limited to a bedroom, a bathroom, a house (e.g., the smart-lock can be installed on a main entrance, or any entrance to a house), a hotel room, a building, or a structure/place secured by a gate onto which the proposed smart-lock can be installed.

Unless the context dictates otherwise, terms such as “first” and “second” are used to arbitrarily distinguish elements and entities. Thus, these terms are not necessarily intended to indicate temporal or other prioritization of such elements or priorities. Whilst various embodiments of the disclosed inventions (such as features, methods, processes, devices, and systems) have been described in this document, it should be understood that the embodiments employed have been presented for purposes of example, and not to limit any of the inventions disclosed in this document to a form represented in any of the embodiments. It should also be noted that the examples and embodiments used to describe the inventions (such as features, methods, processes, devices, and systems) disclosed in this document are to aid understanding—the examples and embodiments employed do not limit any of the inventions described to a particular form. Modifications and variations are possible in light of the description below or may be acquired from practicing of the inventions (such as features, methods, processes, devices, and systems) disclosed in this document, without departing from the breadth or scope of the said inventions.

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will however recognize that the various embodiments can be practiced without one or more of the disclosed details/features, or with other methods, components, materials, etc. In other instances, well-known structures, materials, or operations are not shown or described in detail to avoid obfuscation. The following description is intended only by way of example, and simply illustrates certain example embodiments.

Although other devices (such as the wireless remote, and the virtual knocker) are discussed in relation to the smart-lock—it should be noted that the smart-lock can function independently of other devices.

The smart-lock will now be described with reference to the accompanying drawings, which should be regarded as merely illustrative without restricting the scope and ambit of the smart-lock.

FIG. 1 shows a top perspective view of an environment of a system 100, in accordance with an embodiment of the smart-lock 108. The system 100 shows a room 102, a door 104 of the room 102, a smart-lock 108 fitted or installed on to the door 104, and a door latch 106 (which the smart-lock 108 may include). The system 100 also shows a virtual knocker 112 (a device later discussed in the section of this document entitled “The virtual knocker”), and a wireless remote 114 (a device later discussed in the section of this document entitled “The wireless remote”). In an embodiment, the smart-lock 108 can be connected over a communication network (such as the network 110). Similarly, the virtual knocker 112 and the wireless remote 114 can be connected over a communication network (such as the network 110).

In an embodiment, the smart-lock 108 may comprise suitable logic, circuitry, interfaces, and/or code, executable by the circuitry that can be configured to perform one or more operations. Throughout this document, references to the smart-lock 108 applying/activating its locks (or locking the door 104 of the room 102) entail the triggering (by the smart-lock 108) of a locking mechanism (or otherwise) that would cause the door 104 of the room 102 to be/become locked. Similarly, throughout this document, references to the smart-lock 108 retracting/deactivating its locks (or unlocking the door 104 of the room 102) entail the smart-lock 108 triggering a locking mechanism (or otherwise) that would cause the door 104 of the room 102 to be/become unlocked. Additionally, throughout this document, unless the context dictates otherwise, references to the smart-lock 108 or a user unlocking a door (such as the door 104 of the room 102) entail the smart-lock 108 retracting its locks. Similarly, throughout this document, unless the context dictates otherwise, references to the smart-lock 108 or a user locking a door (such as the door 104 of the room 102) entail the smart-lock 108 applying its locks.

The smart-lock 108 includes a locking-unlocking device as a means of locking and unlocking the door 104 of the room 102. Throughout this document, discussions regarding the locks of the smart-lock 108 (such as when the locks of the smart-lock 108 are said to be “applied” or “retracted”) are in relation to the locking-unlocking device that is comprising the smart-lock 108. Any suitable locking-unlocking device (that can be configured to be controlled by the smart-lock 108) may be included on the smart-lock 108 for the purpose of locking and unlocking the door 104 of the room 102. Examples of devices that can be included on the smart-lock 108 (for the purpose of locking and unlocking the door 104 unto which the smart-lock 108 is installed) include and is not limited to a latch bolt (that can be controlled by the smart-lock 108), a dead latch (that can be controlled by the smart-lock 108), a deadbolt (that can be controlled by the smart-lock 108), a mortice lock (that can be controlled by the smart-lock 108), a sash lock (that can be controlled by the smart-lock 108), a magnetic lock (that can be controlled by the smart-lock 108), or any combination thereof. Alternatively, the smart-lock 108 can be connected (via a wired or wireless connection) to a separate locking-unlocking device such as a magnetic lock; the smart-lock 108 could then lock and unlock the door 104 of the room 102 by communicating with the locking-unlocking device. In an embodiment, the locking-unlocking device that can comprise the smart-lock 108 (for the purpose of locking and unlocking the door 104 of the room 102) can be an electromagnetic locking device—this embodiment may be ideal for public places such as public toilet cubicles.

In an embodiment, the smart-lock 108 may comprise a pair (with one comprising the interior side 202 of the smart-lock 108, and the other comprising the exterior side 204 of the smart-lock 108) of door handles, doorknobs, or the likes as a means to allow users to open the door 104 of the room 102 through physical handling (which can for example by turning the door handles/doorknobs comprising either side of the smart-lock 108). The pair of door handles/doorknobs can be configured to allow users to operate the door latch 106 that can comprise the smart-lock 108. When the locks of the smart-lock 108 are said to be applied (whilst the door 104 of the room 102 is closed)—it means that the locking-unlocking device that is comprising the smart-lock 108 is in a state whereby the turning of any door handle (or doorknob, or the likes) that may be comprising the exterior side 204 of the smart-lock 108 would not allow the door 104 of the room 102 to open. Hence, should a user who is outside the room 102 attempt to turn a door handle that is comprising the exterior side 204 of the smart-lock 108 whilst the locks of the smart-lock 108 are applied—then he/she would be unable to open the door 104. In an embodiment, the smart-lock 108 may comprise a door latch 106. The smart-lock 108 can be configured to control/operate the door latch 106 as a means of locking and unlocking the door 104 of the room 102—whereby (whilst the locks of the smart-lock 108 are applied), the turning of any door handle (or doorknob, or the likes) that may comprise the exterior side 204 of the smart-lock 108 would not result in the door latch 106 being pulled back (thereby keeping the door 104 locked and closed).

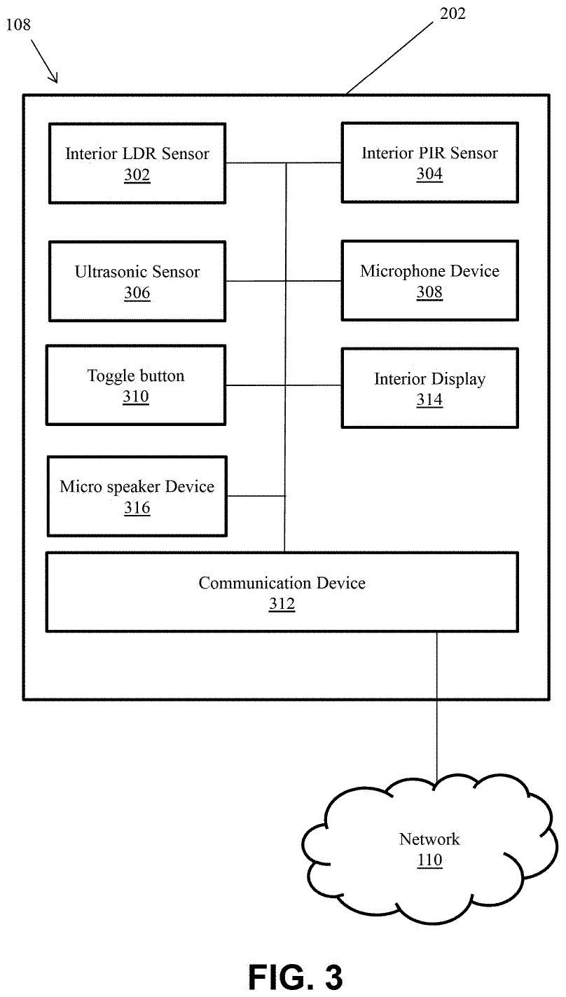

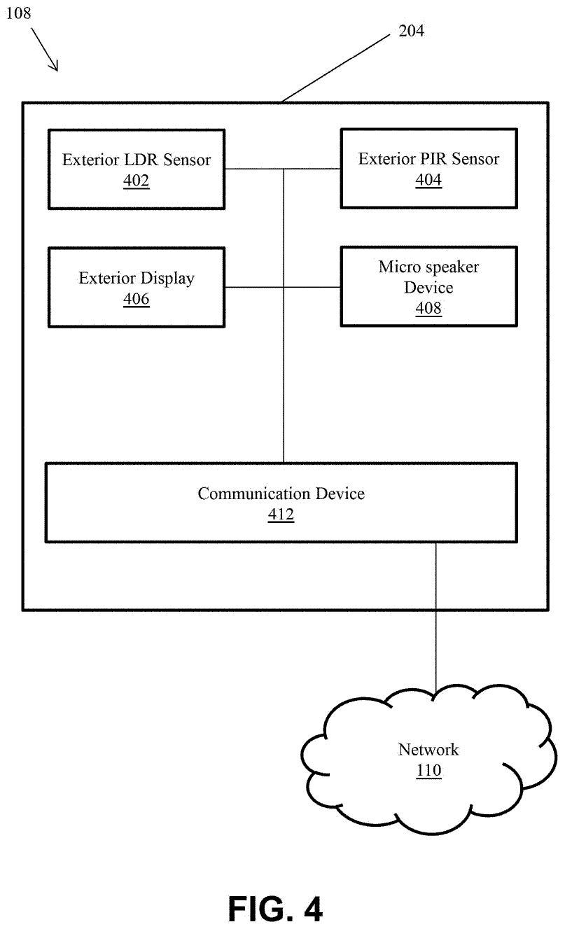

In an embodiment, the smart-lock 108 can include one or more (using the same or different technologies) sensors (such as a Light Dependent Resistor (LDR) sensor, Passive Infrared (PIR) sensor, ultrasonic sensor, or the like) that can function in conjunction with each other or individually to achieve various functions such as detecting the presence of any user inside the room 102, Similarly, the smart-lock 108 can include one or more sensors (using the same or different technologies) for the purpose of detecting the presence of any user outside the room 102 (i.e., in the vicinity or in front of the door 104). Detailed descriptions of various sensors that the smart-lock 108 may comprise are later described in conjunction with FIG. 3 and FIG. 4. In an embodiment, the smart-lock 108 can be configured to automatically apply its locks (i.e., lock the door 104 of the room 102) whenever it (i.e., the smart-lock 108) deems that the room 102 is occupied. Similarly, the smart-lock 108 can be configured to ensure that its locks are retracted (i.e., unlock the door 104 of the room 102) whenever it (i.e., the smart-lock 108) deems that the room 102 is vacant.

In an embodiment, the smart-lock 108 can include a display (i.e., the exterior display 406 as shown in FIG. 4) as a means of displaying the occupancy status of the room 102. The exterior display 406 can be included on the exterior side 204 of the smart-lock 108 such that the exterior display 406 may be visible on the exterior side 204 of the smart-lock 108. Should the door 104 be closed—the exterior display 406 would be visible from outside the room 102. In an embodiment, the smart-lock 108 can include a display (i.e., the interior display 314 as shown in FIG. 3) as a means of displaying its lock status (i.e., display whether the locks of the smart-lock 108 are applied or retracted). The interior display 314 can be included on the interior side 202 of the smart-lock 108 such that the interior display 314 may be visible on the interior side 202 of the smart-lock 108. Should the door 104 be closed—the interior display 314 would be visible from inside the room 102.

In an embodiment, the interior side 202 of the smart-lock 108 may comprise a micro speaker device 316. The micro speaker device 316 is an electronic device that can be configured to produce audible sounds. Example of sounds that the micro speaker device 316 may produce include and is not limited to a tone (such as a beep) and a pre-recorded voice message. Furthermore, as the output sound can be heard from (at least) the interior side 202 of the smart-lock 108, the micro speaker device 316 can therefore be used by the smart-lock 108 to alert or notify users (such as a user who is inside the room 102) of the lock status of the smart-lock 108 in an audible manner (such as using a beep, a tune, or spoken words). In another example, sound from the micro speaker device 316 can be used by the smart-lock 108 to draw a user's attention to the interior display 314.

In an embodiment, the smart-lock 108 can also function as an intelligent controlling device. The smart-lock 108 can include a communication device (shown in FIG. 3 and FIG. 4) that can be configured to communicate with one or more smart devices/appliances. The one or more smart devices may correspond to one or more smart light bulbs, smart light switches, smart power switches, smart air conditioners, smart fans, or the like. In an embodiment, the smart-lock 108 can be configured to control/operate one or more smart devices based on the occupancy status of the room 102. By communicating with a smart device, the smart-lock 108 can intelligently control/operate such device; this can for example include the smart-lock 108 turning such device on and off, or adjusting the settings or the manner in which such device operates based on the occupancy status of the room 102. In an embodiment, the smart-lock 108 can be configured to control/operate one or more smart devices based on instructions (such as oral instructions that can be captured by the microphone device 308) provided by a user. In an embodiment, the smart-lock 108 can be configured to control/operate one or more smart devices based on an instruction/command provided by another electronic device (such as a smart home hub, or another smart device), Some operations of the smart-lock 108 are later discussed in conjunction with FIG. 3 and FIG. 4.

The virtual knocker 112 may comprise suitable logic, circuitry, interfaces, and/or code, executable by the circuitry that can be configured to perform one or more operations. The virtual knocker 112 can be placed outside the room 102 (for example, on the door 104). The virtual knocker 112 can be configured to inform any user (who is outside the room 102) of the occupancy status (be it vacant or occupied) of the room 102. Using the virtual knocker 112 to display the occupancy status of the room 102 can be suited to a scenario in which the user does not own a smart-lock 108 or a scenario in which the smart-lock 108 is not installed on the door 104 of the room 102; in such cases, the user can instead use the virtual knocker 112 to display the occupancy status of the room 102. The virtual knocker 112 can be configured to obtain/acquire data/information pertaining to any presence detected inside the room 102 from the wireless remote 114 or any motion/presence detection device inside the room 102. The virtual knocker 112 can function with or without the smart-lock 108. Likewise, the smart-lock 108 can function with or without the virtual knocker 112. The virtual knocker 112 is later discussed in the section of this document entitled “The virtual knocker”.

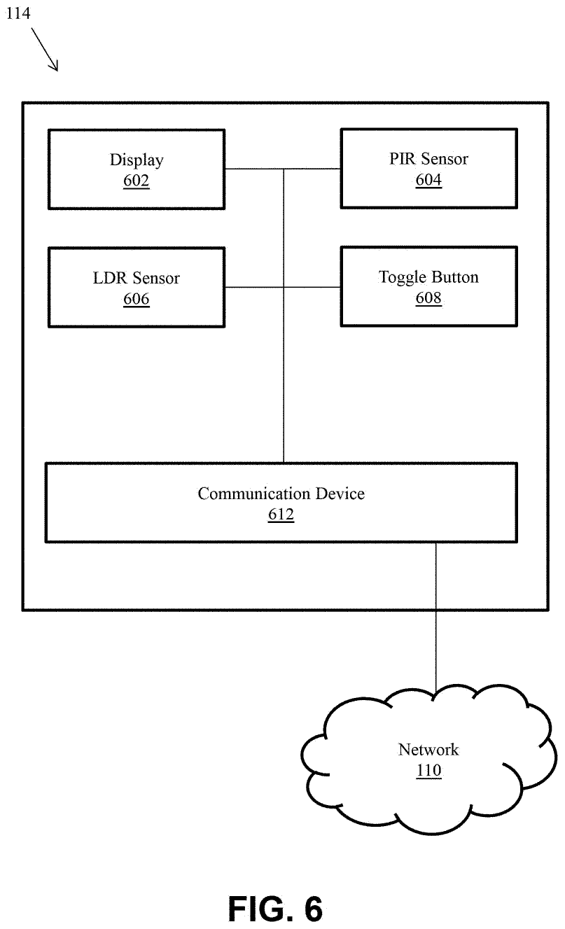

The wireless remote 114 may comprise suitable logic, circuitry, interfaces, and/or code, executable by the circuitry that can be configured to perform one or more operations. The wireless remote 114 can be located inside the room 102. In accordance with an embodiment of the smart-lock 108, the wireless remote 114 can be configured (or strategically placed in the room 102) to cover an area/areas that is not in the field of view of the smart-lock 108 (i.e., to cover one or more blind spots). Hence, the wireless remote 114 can be useful in detecting a presence inside the room 102. The wireless remote 114 can include a display (such as the display 602 shown in FIG. 6) that can provide a way for any user inside the room 102 to view the lock status of the smart-lock 108 when he/she is not looking at the interior display 314 of the smart-lock 108. The wireless remote 114 can also include a speaker (such as the micro speaker device 610 shown in FIG. 6) which can be configured to express the lock status of the smart-lock 108 in an audible manner. The wireless remote 114 can also include a toggle button (such as the toggle button 608 shown in FIG. 6). The toggle button 608 comprising the wireless remote 114 can be configured to allow any user inside the room 102 to wirelessly control (i.e., lock and unlock) the smart-lock 108. The smart-lock 108 can function with or without the wireless remote 114. Likewise, the wireless remote 114 can function with or without the smart-lock 108. The wireless remote 114 is later discussed in the section of this document entitled “The wireless remote”.

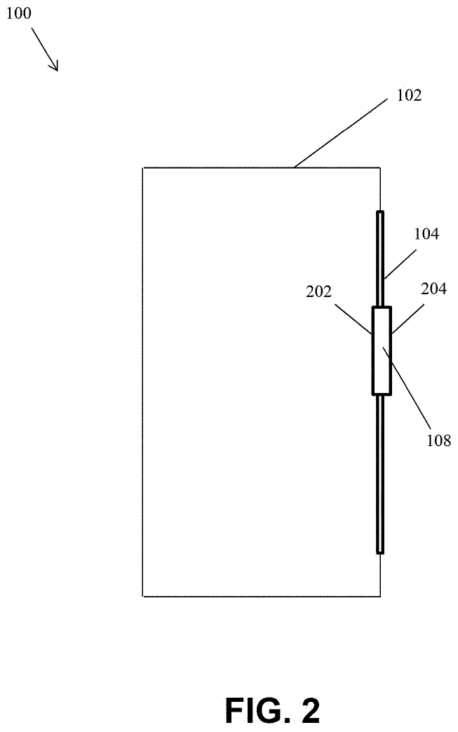

FIG. 2 shows a side view of the system 100, in accordance with an embodiment of the smart-lock 108. The system 100 shows the room 102, the door 104 of the room 102, and the smart-lock 108 fitted or installed on to the door 104. The system 100 further shows the interior side 202 of the smart-lock 108 and an exterior side 204 of the smart-lock 108. In an embodiment, the smart-lock 108 can have two sides (i.e., the interior side 202 of the smart-lock 108 and the exterior side 204 of the smart-lock 108). In an embodiment, the interior side 202 of the smart-lock 108 is the side of the smart-lock 108 that a user may be facing when he/she is operating the smart-lock 108 (through physical contact/handling) from inside (i.e., from inside the room 102 whose door 104 has the smart-lock 108 installed or fitted onto it). In an embodiment, the exterior side 204 of the smart-lock 108 is the side of the smart-lock 108 that a second user may be facing when he/she (i.e., the second user) is operating the smart-lock 108 (through physical contact/handling) from outside (i.e., from outside the room 102 whose door 104 has the smart-lock 108 installed or fitted onto it).

FIG. 3 shows various components included on the interior side 202 of the smart-lock 108, in accordance with an embodiment of the smart-lock 108. It can be assumed that the interior side 202 of the smart-lock 108 is installed/fitted on the door 104 of the room 102. The interior side 202 of the smart-lock 108 can be mounted on the side of the door 104 that a user may face when inside the room 102 (whilst the door 104 is closed). In an embodiment, the interior side 202 of the smart-lock 108 can include one or more sensors such as an interior LDR sensor 302, an interior PIR sensor 304, and an ultrasonic sensor 306. In an embodiment, the interior side 202 of the smart-lock 108 can further include a microphone device 308, a toggle button 310, a communication device 312, a micro speaker device 316, and a display (i.e., the interior display 314). The interior LDR sensor 302 is a light sensor that can be configured to measure the luminance or the level of brightness inside the room 102.

In an embodiment, the interior side 202 of the smart-lock 108 may comprise a PIR sensor—this is known as the interior PIR sensor 304. The interior PIR sensor 304 is an electronic sensor that can be configured to detect the motion of one or more users. Hence, the interior PIR sensor 304 can be used by the smart-lock 108 to detect the presence of any user inside the room 102 based on the detection of motion inside the room 102. The interior PIR sensor 304 can therefore be used by the smart-lock 108 to determine the occupancy status (i.e., occupied or vacant) of the room 102 based on the detection of motion inside the room 102.

In an embodiment, the smart-lock 108 may comprise an alternative means (an alternative to using the interior PIR sensor 304) of detecting a presence inside the room 102—examples of such alternatives include and is not limited to using an ultrasonic sensor (such as the ultrasonic sensor 306), or a microphone device (such as the microphone device 308). In an embodiment, the smart-lock 108 may comprise more than one means of detecting a presence inside the room 102. For example, the smart-lock 108 can utilize the interior PIR sensor 304, the ultrasonic sensor 306, the microphone device 308, or any combination thereof to ascertain the occupancy status of the room 102. Any suitable technology (be it a single technology/device, or a combination of technologies/devices) can be included on the smart-lock 108 for the purpose of detecting a presence inside the room 102. Using more than one means of detecting a presence inside the room 102 can enable the smart-lock 108 to better gauge the occupancy status of the room 102 (i.e., it can enable the smart-lock 108 to be more accurate in calculating/assessing the occupancy status of the room 102—especially when blind spots are reduced/limited). Millimeter-wave (mmWave) radar is a technology that is able to detect fine/subtle movements (such as a user's breathing or a user sitting still). Hence, the smart-lock 108 comprising a mmWave sensors on its interior side 202 could allow the smart-lock 108 to detect finer/more subtle movements (inside the room 102) than a PIR sensor (such as the interior PIR Sensor 304).

In an embodiment, the smart-lock 108 can be configured to automatically apply its locks (i.e., lock the door 104 of the room 102) whenever a presence is detected (by the smart-lock 108 or any capable device) inside the room 102—this feature is further discussed in the section of this document entitled “Automatic locking”. Thus, should the smart-lock 108 be configured to automatically apply its locks (i.e., lock the door 104 of the room 102) whenever a presence is detected inside the room 102, then a second user (who is outside the room 102 and trying to open the door 104 of the room 102) would be unsuccessful in his/her attempt to open the door 104 of the room 102 should the room 102 be deemed occupied by the smart-lock 108 at the time of the attempt.

In an embodiment, the interior side 202 of the smart-lock 108 may comprise an ultrasonic sensor 306. The ultrasonic sensor 306 is an electronic sensor that can be configured to detect the motion of one or more users. Hence (in lieu or in addition to the interior PIR sensor 304), the ultrasonic sensor 306 can be used by the smart-lock 108 to determine the occupancy status (i.e., occupied or vacant) of the room 102 based on the detection of motion inside the room 102.

In an embodiment, the interior side 202 of the smart-lock 108 may comprise a microphone device 308. The microphone device 308 is an electronic device or sensor that can be configured to detect sound. The smart-lock 108 can be configured to utilize sound detected by the microphone device 308—sound detected by the microphone device 308 can be used in a variety of operations. For example (in lieu of or in addition to another means of detecting a presence inside the room 102), the smart-lock 108 can be configured to utilize sound detected by the microphone device 308 to estimate/gauge the occupancy status of the room 102 by intelligently analyzing sound that is being produced inside the room 102. Whilst silence may suggest that the room 102 is vacant, examples of sounds (detected inside the room 102) that the smart-lock 108 may consider in assessing the occupancy status of the room 102 include and is not limited to the sound of water (running, splashing or otherwise), the voice of any user inside the room 102, sound of movements, and sound of a fan. In gauging the occupancy status of the room 102 using the microphone device 308, the smart-lock 108 may also take into account (by a way of comparing and benchmarking) any sound that is originating outside the room 102 (should the smart-lock 108 include a means of detecting sound outside the room 102). Furthermore, the microphone device 308 could be positioned/configured in a way that can allow for the detection of sound both inside and outside the room 102. In an embodiment, the smart-lock 108 can also be configured to utilize the microphone device 308 to detect voice commands made by users. Examples of requests that a user (such as a user who is inside the room 102) may direct at the smart-lock 108 include and is not limited to a request for the smart-lock 108 to apply its locks, a request for the smart-lock 108 to retrack its locks, and a request for the smart-lock 108 to turn on a smart device (e.g., a smart light bulb) that it has been configured to operate.

The toggle button 310 may comprise suitable logic, circuitry, interfaces, and/or code, executable by the circuitry that can be configured to perform one or more operations. For example, the toggle button 310 can be configured to provide a means of manually locking/unlocking the smart-lock 108—this is further discussed in the section of this document entitled “Manual locking”. In another example, the toggle button 310 can be configured to activate and deactivate do not disturb on the smart-lock 108—this is further discussed in the section of this document entitled “Do not disturb mode”.

The interior display 314 may comprise suitable logic, circuitry, interfaces, and/or code, executable by the circuitry that can be configured to perform one or more display operations. For example, the interior display 314 can be configured to display the lock status of the smart-lock 108 (i.e., display whether the locks of the smart-lock 108 are applied or retracted). The lock status of the smart-lock 108 is an indication of whether the room 102 is locked (i.e., the locks of the smart-lock 108 are applied) or unlocked (i.e., the locks of the smart-lock 108 are retracted). Examples of display technologies that can be used to display (on the interior display 314) the lock status of the smart-lock 108 include and is not limited to a Liquid-Crystal Display (LCD), a Light-Emitting Diode (LED) display, an Organic Light-Emitting Diode (OLED) display, an electronic paper display (such as, for example, an e-ink display by the E Ink Corporation), a segment LCD display, a segment LED display, one or more LED indicator, and a mechanically operated display having moving parts, or any combination thereof. In an embodiment, the lock status of the smart-lock 108 could be visually expressed on the interior side 202 of the smart-lock 108 (on for example (and not limited to) the interior display 314) by displaying any combination of characters (such as letters and words), symbols, images, and colors that could be interpreted/understood by a user (such as a user who is inside the room 102) to indicate the lock status of the smart-lock 108.

In an embodiment, the smart-tock 108 can be configured to communicate with other devices over a communication network (such as the network 110). Examples of technologies that can be used for the network 110 include, but is not limited, to a Bluetooth network (such as a mesh), a Wi-Fi network, a Local Area Network (LAN), a Wide Area Network (WAN), a Metropolitan Area Network (MAN), a satellite network, a mobile network data connection (such as 3G, 4G/LTE and 5G), the Internet, a fiber optic network, a coaxial cable network, an infrared (IR) network, a radio frequency (RF) network, a Z-Wave network, a Zigbee network, any combination thereof, or any other suitable technology.

The communication device 312 may comprise suitable logic, circuitry, interfaces, and/or code, executable by the circuitry that can be configured to transmit and receive queries, messages, requests, signals, and commands between various entities of the system 100 over the network 110. Examples of technologies that can be used for the communication device 312 include and is not limited to an antenna, a radio frequency transceiver, a wireless transceiver, a Wi-Fi transceiver, a Bluetooth Low Energy (BLE) transceiver, a Bluetooth Classic transceiver, a Z-Wave transceiver, a Zigbee transceiver, or any combination thereof. The communication device 312 can be configured to communicate with the various entities of the system 100 or other entities that are outside the system 100 using various wired and/or wireless communication protocols, such as Transmission Control Protocol and Internet Protocol (TCP/IP), User Datagram Protocol (UDP), Long Term Evolution (LTE) communication protocols, or any combination thereof.

FIG. 4 shows various components on the exterior side 204 of the smart-lock 108, in accordance with an embodiment of the smart-lock 108. It can be assumed that the exterior side 204 of the smart-lock 108 is installed/fitted on the door 104 of the room 102. The exterior side 204 of the smart-lock 108 can be mounted on the side of the door 104 that a user may face when outside the room 102 (whilst the door 104 is closed). The various components on the exterior side 204 of the smart-lock 108 can include one or more sensors such as the exterior LDR sensor 402 and the exterior PIR sensor 404. The exterior side 204 of the smart-lock 108 can further include a display (i.e., the exterior display 406), a micro speaker device 408, and a communication device 412.

In an embodiment, the exterior side 204 of the smart-lock 108 may comprise an LDR sensor—this is known as the exterior LDR sensor 402. The exterior LDR sensor 402 is a light sensor that can be configured to measure the luminance or the level of brightness on the exterior side 204 of the smart-lock 108. This means that the exterior LDR sensor 402 can measure the luminance or the level of brightness of the area surrounding the exterior side 204 of the smart-lock 108. As previously discussed, the smart-lock 108 can be configured to visually display the occupancy status of the room 102 on its exterior display 406. However, having a low level of brightness in the area surrounding the exterior side 204 of the smart-lock 108 could make it difficult for a user to see the occupancy status of the room 102 when displayed on the exterior display 406. Hence, it may be useful for the smart-lock 108 to include a means of illumination on its exterior side 204 for the purpose of increasing visibility when visually notifying/alerting the user of the occupancy status of the room 102. Should the smart-lock 108 deem (by measuring the level of brightness on its exterior side 204 using the exterior LDR sensor 402) the surroundings of its exterior side 204 dark enough to warrant illumination, then the smart-lock 108 could illuminate its exterior display 406 (or apply other means (such as using LED or OLED technology) of illuminating its exterior side 204) when alerting/notifying a user of the occupancy status of the room 102. The smart-lock 108 could also utilize measurements from the exterior LDR sensor 402 to determine the level (in terms of brightness) of illumination (be it in the form of a backlight on the exterior display 406, or other means (such as using LED or OLED technology) of illumination) that it should output on its exterior side 204 for optimal visibility.

Furthermore, the smart-lock 108 can be configured to also utilize measurements from the exterior LDR sensor 402 to determine whether or not a user should be alerted/notified of the occupancy status of the room 102 in an audible manner (e.g., using micro speaker device 408). For example, the smart-lock 108 could provide an audible notification (i.e., using micro speaker device 408) of the occupancy status of the room 102 to a user should it (i.e., the smart-lock 108) deem the surrounding of its exterior side 204 dark enough to warrant an audible notification. An audible notification of the occupancy status of the room 102 can be provided in lieu or in addition to a visual notification of the occupancy status of the room 102.

In an embodiment, the exterior side 204 of the smart-lock 108 may comprise a PIR sensor—this is known as the exterior PIR sensor 404. The exterior PIR sensor 404 is an electronic sensor that can be configured to sense the motion of one or more users. For example, the exterior PIR sensor 404 can enable the smart-lock 108 to detect the presence of a second user (i.e., a user who is outside the room 102 and in the vicinity or in front of the door 104 of the room 102, or approaching the door 104 from outside) based on the detection of motion of the user in the vicinity or in front of the door 104 of the room 102. The exterior PIR sensor 404 can be used in the process called “virtual knock”—this is further discussed in the section of this document entitled “Virtual knock”.

The exterior display 406 may comprise suitable logic, circuitry, interfaces, and/or code, executable by the circuitry that can be configured to perform one or more display operations. For example, the exterior display 406 can be configured to display the occupancy status of the room 102 (i.e., display whether the room 102 is vacant or occupied). Examples of display technologies that can be used to display (on the exterior display 406) the occupancy status of the room 102 include and is not limited to an LCD display, an LED display, an OLED display, an electronic paper display (such as, for example, an e-ink display by the E Ink Corporation), a segment LCD display, a segment LED display, one or more LED indicator, a mechanically operated display having moving pans, or any combination thereof. The occupancy status of the room 102 can be visually displayed or expressed on the exterior side 204 of the smart-lock 108 (on for example (and not limited to) the exterior display 406) by displaying any combination of characters (such as letters and words), symbols, images, and colors that could be interpreted/understood by a user (such as a user who is outside the room 102) to indicate the occupancy status of the room 102.

In an embodiment, the exterior side 204 of the smart-lock 108 may comprise a micro speaker device 408. The micro speaker device 408 is an electronic device that can be configured to produce audible sounds, Example of sounds that the micro speaker device 408 may produce include and is not limited to a tone (such as a beep) and a pre-recorded voice message. Furthermore, as the output sound can be heard from (at least) the exterior side 204 of the smart-lock 108, the micro speaker device 408 can therefore be used by the smart-lock 108 to alert or notify a second user of the occupancy status of the room 102 in an audible form (such as, for example, by using a beep, a tune, or spoken words). In another example, sound from the micro speaker device 408 can be used by the smart-lock 108 to draw a user's attention to the exterior display 406.

The communication device 412 may comprise suitable logic, circuitry, interfaces, and/or code, executable by the circuitry that can be configured to transmit and receive queries, messages, requests, signals, and commands between various entities of the system 100 over the network 110. Examples of technologies that can be used for the communication device 412 include and is not limited to an antenna, a radio frequency transceiver, a wireless transceiver, a Wi-Fi transceiver, a Bluetooth Low Energy (BLE) transceiver, a Bluetooth Classic transceiver, a Z-Wave transceiver, a Zigbee transceiver, or any combination thereof. The communication device 412 can be configured to communicate with the various entities of the system 100 or other entities that are outside the system 100 using various wired and/or wireless communication protocols, such as Transmission Control Protocol and Internet Protocol (TCP/IP), User Datagram Protocol (UDP), Long Term Evolution (LTE) communication protocols, or any combination thereof. Note that the communication device 412 and the communication device 312 may be the same device or separate/different devices.

### Operations, Applications, and Advantages

### Automatic Locking

The occupancy status of the room 102 can be calculated/computed by the smart-lock 108 using data/information acquire from or using one or more sensors (such as the interior PIR sensor 304) or using data/information acquired from any device that the smart-lock 108 may be connected to (such as a motion/presence detector) for the purpose of acquiring data/information regarding any presence detected inside the room 102. The occupancy status of the room 102 is an indication of whether the room 102 is engaged/occupied (i.e., a presence (one or more) can be detected inside the room 102) or vacant/free (i.e., no presence can be detected inside the room 102).

In an embodiment, the smart-lock 108 can be configured to utilize the occupancy status of the room 102 to perform actions such as automatically applying its locks whenever it (i.e., the smart-lock 108) detects/deems that the room 102 is occupied (i.e., a presence can be detected inside the room 102). Similarly, in an embodiment, the smart-lock 108 can be configured to ensure that its locks are not applied whenever it deems that the room 102 is vacant (i.e., no presence can be detected inside the room 102). The automatic locking of the door 104 based on the occupancy status of the room 102 can be particularly useful when used on the door of a bathroom, a shower-room, or a washing closet. This is because a user may unknowingly leave the door 104 unlocked ater having entered a room (such as the room 102) in which he/she may desire privacy. The smart-lock 108 could solve this problem when configured to automatically applying its locks whenever it (i.e., the smart-lock 108) deems that the room 102 is/has become occupied. In an embodiment, the smart-lock 108 can include door handles (or doorknobs, or the likes).

In an embodiment, a presence/motion detection sensor (such as, for example, the interior PIR sensor 304) can be included on the door handle (or doorknob) that can comprise the interior side 202 of the smart-lock 108 for the purpose of detecting when there is a presence inside the room 102. It may be useful to configure the smart-lock 108 such that any presence/motion detection sensor (such as, for example, the interior PIR sensor 304) that may be included on its interior door handle or doorknob (i.e., a door handle or doorknob that can be included on the interior side 202 of the smart-lock 108) does not (or becomes less likely to) incorrectly interpret motion (i.e., a sign that someone is inside the room 102) whilst the interior door handle (or doorknob) itself is in motion. The interior door handle (or doorknob) may for example be in motion/moving as a result of a user (who is outside the room 102) turning the exterior door handle (in a bid to open the door 102) which can in-turn cause the interior door handle (or doorknob) to turn/tilt/move. Hence, it may be useful to configure the smart-lock 108 such that motion detected by the said motion/presence detection sensor (which can be included on the interior door handle for the purpose of detecting a presence inside the room 102) whilst the door 104 is in motion (and/or whilst the interior door handle (or doorknob) is being turned/tilted/moved) is not incorrectly interpreted. It may therefore be useful to include one or more sensor (such as, for example, an accelerometer) that can allow the smart-lock 108 to detect when the door handle (or doorknob) comprising its interior side 202 is being turned/tilted/moved. The smart-lock 108 could then appropriately/intelligently handle motion detected by any presence/motion detection sensor (such as the interior PIR sensor 304) that may be included on its interior side 202 (such as on its interior door handle (or doorknob)) whilst the said door handle (or doorknob) is being turned/tilted/moved (and/or whilst the door 104 itself is in motion)—this may reduce the likelihood of smart-lock 108 incorrectly concluding/deeming that there is a presence inside the room 102 whilst its interior door handle (or doorknob) is being turned/tilted/moved.

The smart-lock 108 could be configured to ensure that its locks are not applied (which may mean the smart-lock 108 retracting its locks (if they were applied)) whenever it is not able to establish/conclude that there is a presence inside the room 102 once the door 104 closes—this automatic/intelligent unlocking feature could be useful should the smart-lock 108 be configured to automatically apply its locks whenever it deems that there is a presence inside the room 102 (as the likelihood of the smart-lock 108 erroneously automatically applying its locks whilst the room 102 is vacant will be reduced or eliminated).

### Manual Locking

As previously discussed in the section of this document entitled “Automatic locking”, the smart-lock 108 can be configured to automatically apply its locks (i.e., lock the door 104 of the room 102) based on the occupancy status (i.e., vacant or occupied) of the room 102. In an embodiment, the interior side 202 of the smart-lock 108 may comprise a toggle button 310 that can be configured to perform various operations such as locking and unlocking the door 104 of the room 102. This means that the user can manually trigger the smart-lock 108 to apply its locks (i.e., locking the door 104 of the room 102) and also trigger the smart-lock 108 to retract/deactivate its locks (i.e., unlock the door 104 of the room 102) by pressing the toggle button 310 comprising the interior side 202 of the smart-lock 108. In an alternative embodiment, the smart-lock 108 may comprise one button for applying its locks (i.e., locking the door 104 of the room 102) and a separate button for deactivating/retracting the locks of the smart-lock 108 (i.e., unlocking the door 104 of the room 102).

### The Interior Display

As previously discussed, the smart-lock 108 can be configured to display (on the exterior display 406) the occupancy status of the room 102. In an embodiment, the interior side 202 of the smart-lock 108 may comprise a display—this is known as the interior display 314. The interior display 314 can be configured to display the lock status of the smart-lock 108 (i.e., display whether the locks of the smart-lock 108 are applied or retracted) for any user inside the room 102 to see. The smart-lock 108 can be configured to indicate (on the interior display 314) when its locks are applied (i.e., indicate that the room 102 is locked) by displaying any combination of characters (such as letters and words), symbols, images, and colors that could be interpreted/understood by a user (such as a user who is inside the room 102) to mean that the room 102 is locked (i.e., that the locks of the smart-lock 108 are applied). Similarly, the smart-lock 108 can be configured to indicate (on the interior display 314) when its locks are not applied (i.e., indicate that the room 102 is unlocked) by displaying any combination of characters (such as letters and words), symbols, images and colors that could be interpreted/understood by a user (such as a user who is inside the room 102) to mean that the room 102 is unlocked (i.e., that the locks of the smart-lock 108 are retracted). Additionally, the smart-lock 108 can be configured to indicate (on the interior display 314) when its locks are not applied (i.e., indicate that the room 102 is unlocked) by displaying a blank/empty screen).

As previously discussed, the smart-lock 108 can be configured to automatically apply its locks (i.e., lock the door 104 of the room 102) based on the occupancy status (i.e., whether the room 102 is vacant or occupied) of the room 102. Hence, a key advantage of displaying the lock status of the smart-lock 108 (i.e., display whether the door 104 is locked or unlocked —assuming that the smart-lock 108 is the only lock installed on the door 104) on the interior display 314 of the smart-lock 108 is that it could reassure any user (who is inside the room 102) of the lock status of the smart-lock 108, This means that should the smart-lock 108 be set to automatically apply its locks (i.e., lock the room 102) when it detects that the room 102 has become occupied, then by displaying (on the interior display 314) the lock status of the smart-lock 108—the user would be reassured of their privacy in knowing that the locks have indeed been applied.

Alternatively, or additionally, the lock status of the smart-lock 108 can be expressed in an audible form. A micro speaker device (which comprises the smart-lock 108) can for example output sound that could be interpreted/understood by a user to mean that the smart-lock 108 has either applied its locks (i.e., the room 102 is locked) or that the locks of the smart-lock 108 are retracted (i.e., the room 102 is unlocked). The sound outputted by the smart-lock 108 to mean that the room 102 is locked and the sound outputted by the smart-lock 108 to mean that the room 102 is unlocked can be the same sound or different sounds.

In an embodiment, the lock status of the smart-lock 108 could be visually expressed on the interior side 202 of the smart-lock 108 (on for example (and not limited to) the interior display 314)—the lock status could be expressed with any combination of characters (such as letters and words), symbols, images, and colors that could be interpreted/understood by a user (such as a user who is inside the room 102) to indicate the lock status of the smart-lock 108. Alternatively, or additionally, the lock status of the smart-lock 108 could be expressed in an audible form. A micro speaker device (such as, for example, the micro speaker device 316) can for example output sound that could be interpreted/understood by a user to mean that the smart-lock 108 has either applied its locks (i.e., the room 102 is locked) or that the locks of the smart-lock 108 have been retracted (i.e., the room 102 is unlocked).

### Virtual Knock

As previously discussed, as well as the interior PIR sensor 304 on the interior side 202 of the smart-lock 108, the smart-lock 108 can also include the exterior PIR sensor 404 on its exterior side 204. The exterior PIR sensor 404 is a PIR sensor that a user (such as a second user) could be facing when operating (through physical contact/handling) the smart-lock 108 from outside (i.e., from outside the room 102 whose door 104 has the smart-lock 108 installed onto it). The exterior PIR sensor 404 can be used in the process called “virtual knock”. Virtual knock can be used to notify or inform any user (who is outside the room 102) of the occupancy status of the room 102. This is different from a user knocking the door 104 of the room 102 as the user would not need to physically knock the door 104 of the room 102 before having an indication of the occupancy status of the room 102. As previously discussed, the smart-lock 108 can be configured to detect or acquire the occupancy status of the room 102 by using its interior PIR sensor 304 or by other means. Additionally, the smart-lock 108 can be configured to detect (e.g., using the exterior PIR sensor 404) when a user (such as a user who is outside the room 102) approaches its exterior side 204. Virtual knock can be described as the process or action of the smart-lock 108 notifying/alerting a user (such as a user who is outside the room 102) of the occupancy status of the room 102 as he/she steps near (or in front of) the door 104 of the room 102. The notification provided by the smart-lock 108 can be visual (displayed on the exterior display 406 of the smart-lock 108) and/or audible (i.e., at least audible from the exterior side 204 of the smart-lock 106).

Once the smart-lock 108 detects a presence on its exterior side 204, the smart-lock 108 can automatically display the occupancy status of the room 102 and/or provide an audible cue or notification of the occupancy status of the room 102. Virtual knock can be particularly useful on a bathroom/toilet's door (or other rooms where privacy may be desired). This is because the user (such as a second user) would have been notified of the occupancy status of the room 102 even before attempting to open the door 104. And as the smart-lock 108 can be configured to automatically apply its locks when it deems the room 102 to be occupied—the user (such as a second user) may be unsuccessful in his/her attempt to open the door 104 of the room 102 should he/she miss a notification or cue (be it visual, audio, or both) from the smart-lock 108 regarding the occupancy status of the room 102.

In an embodiment, the exterior side 204 of the smart-lock 108 can be configured to visually (on for example (and not limited to) the exterior display 406) and/or audibly (such as, for example, via the micro speaker device 408) express the lock status of the smart-lock 108. This feature could be used to notify users (such as a user who is outside the room 102 and in the vicinity of the smart-lock 108) of the lock status of the smart-lock 108.

In an embodiment, the exterior side 204 of the smart-lock 108 can include a door handle (or a doorknob) comprising a means of detecting when a user attempts to touch (or is about to touch, or actually touches) the said door handle (or doorknob). The smart-lock 108 can be configured to notify/update (be it visually, and/or audibly) the user (who has touched the said door handle) of the occupancy status of the room 102, and/or the lock status of the smart-lock 108 as he/she touches (or is about to touch) the said door handle (or doorknob). Similarly, a means of detecting touch could also comprise the virtual knocker 112 for it to update/notify (visually and/or audibly) a user (such as a user who has touched or is about to touch the virtual knocker 112) of the occupancy status of the room 102 and/or the lock status of the smart-lock 108 upon being touched by the said user (or as the virtual knocker 112 senses that it is about to be touched).

In an embodiment, the smart-lock 108 can comprise a means of detecting when a user attempts to open the door 104 that it has been fitted on. The exterior side 204 of smart-lock 108 can include a door handle (or a doorknob) comprising a means of detecting when a user turns (or attempts to turn) the said door handle (or doorknob). Technologies that can be used to detect motion in a door handle (or a doorknob) include and is not limited to an accelerometer, and a gyroscope. A sensor could detect when the door handle (or doorknob) comprising the exterior side 204 of the smart-lock 108 is moved (i.e., detect when a user attempts to open the door 104). In an embodiment, the smart-lock 108 can include one or more suitable inertial motion sensor (such as an accelerometer, and/or a gyroscope) that can be configured to detect when the door 104 of the room 102 is moved for the purpose of automation—such automation can for example include automatically turning on the lights of the room 102 as a user opens, attempts to open, or moves the door 104.

As previously discussed, the smart-lock 108 can be configured to automatically update (visually and/or audibly) any user with information (such as the occupancy status of the room 102 and/or the lock status the smart-lock 108) upon the user being detected outside the room 102. In an embodiment, the smart-lock 108 can be configured to (visually and/or audibly) update any user (who is outside the room 102) with information (such as, for example, the occupancy status of the room 102 and/or the lock status the smart-lock 108) upon the pressing of a button—the said button can comprise the exterior side 204 of the smart-lock 108. For example, an illumination-capable button (which can be included on the exterior side 204 of the smart-lock 108) could be configured to express (using various means such as color coding, and different ways of illuminating such as blinking) the occupancy status of the room 102 and/or the lock status the smart-lock 108 upon the said button being pressed by a user. In another example, the smart-lock 108 could be configured to visually express (on its exterior display 406) the occupancy status of the room 102 and/or the lock status the smart-lock 108 upon the pressing of a said button (which can be included on the exterior side 204 of the smart-lock 108). In an embodiment, the smart-lock 108 can be configured to trigger/cause another device (i.e., any suitable capable/applicable device that the smart-lock 108 may be connected to—this can for example include the virtual knocker 112) to visually and/or audibly update users with information (such as the occupancy status of the room 102 and/or the lock status the smart-lock 108) upon the pressing of a said button that can be included on the exterior side 204 of the smart-lock 108. Alternatively, a button comprising a capable device (which can for example be the virtual knocker 112) that may be connected to the smart-lock 108 could be configured in a way that the pressing of the said button can cause the user (who has pressed the said button) to be visually and/or audibly updated (on the said device itself and/or on the exterior side 204 of the smart-lock 108) with information such as the occupancy status of the room 102 and/or the lock status the smart-lock 108.

### Constantly Displaying the Occupancy Status—an Alternative to Virtual Knock

In an embodiment, the smart-lock 108 can make use of the exterior PIR sensor 404 to conserve energy by only displaying the occupancy status of the room 102 whenever the presence of a user (such as a second user) can be detected (e.g., using the exterior PIR sensor 404) on the exterior side 204 of the smart-lock 108. Alternatively, the smart-lock 108 can be configured to constantly display (on the exterior display 406) the occupancy status of the room 102 regardless of whether or not the smart-lock 108 can (or has the ability to) detect a presence on its exterior side 204. One energy efficient means of constantly displaying (regardless of whether or not the smart-lock 108 can (or has the ability to) detect a presence on its exterior side 204) the occupancy status of the room 102 is by using an electronic paper (e-paper) display. Another example of an energy efficient means of constantly displaying (regardless of whether or not the smart-lock 108 can (or has the ability to) detect a presence on its exterior side 204) the occupancy status of the room 102 is by utilizing a mechanically operated lock or occupancy status display. In an embodiment, the exterior side 204 of the smart-lock 108 can include a mechanically operated occupancy status. In such case, the action (be it automatically by the smart-lock 108 or manually by a user) of applying the locks of the smart-lock 108 would cause the mechanically operated display on the exterior side 204 of the smart-lock 108 to indicate that the room 102 is either locked (implying that the room 102 is occupied) or unlocked (implying that the room 102 is vacant).

Should the smart-lock 108 have the ability to detect a presence on its exterior side 204, then an energy efficient backlight system could also be implemented. In such case, the smart-lock 108 can be configured to illuminate its exterior display 406 (such as an e-paper display, or a mechanically operated display) whenever appropriate—this would be a form of “virtual knock”. Examples of when it may be appropriate (assuming that the smart-lock 108 has detected a presence on its exterior side 204) for the smart-lock 108 to illuminate its exterior display 406 include and is not limited to when using the smart-lock 108 during night hours, or whenever the smart-lock 108 deems the surroundings of its exterior side 204 dark enough to warrant enabling the backlight. The intensity of the backlight's brightness can be set to a level that is relative to the level of brightness of the area surrounding the exterior side 204 of the smart-lock 108 (this could for example be measured by the exterior LDR sensor 402).

### Operating Lights

In an embodiment, the smart-lock 108 can also function as an intelligent light switch. The smart-lock 108 can be configured to communicate with and operate smart devices (such as a smart light bulb, a smart light switch, a smart power switch, or the like) via the communication device 312 or 412. As previously discussed, the smart-lock 108 can be configured to detect (e.g., using the interior PIR sensor 304) any presence inside the room 102 and/or to acquire data/information pertaining to any presence detected in the room 102 from a capable device (which can for example include the wireless remote 114) that the smart-lock 108 may be connected to. Furthermore, the smart-lock 108 can be configured to measure (for example, using the interior LDR sensor 302) the luminance or the level of brightness of the room 102 and/or to acquire measurements of the level of brightness inside the room 102 from any capable device (which can for example include the wireless remote 114) that the smart-lock 108 may be connected to.

The smart-lock 108 (by means of the communication device 312 or 412) could therefore intelligently operate a smart light bulb (or a smart light switch, or the like) by measuring the level of brightness inside the room 102 as it detects that a user has entered the room 102 and proceed by deciding whether or not it (i.e., the smart-lock 108) should turn on the light(s)—the light(s) could for example be turned on by the smart-lock 108 sending a message/signal to the smart light bulb (or smart light switch). The smart-lock 108 could also decide the light intensity/brightness that the smart light bulb (or smart light switch) should output by measuring the luminance or the level of brightness inside the room 102 (e.g., using the interior LDR sensor 302). This may ensure that the room 102 doesn't become too bright (or remain too dim) when the smart-lock 108 sends a message/signal to turn on the light(s). Otherwise, the smart-lock 108 could acquire measurements of the luminance or the level of brightness inside the room 102 by communicating (via a wireless or wired medium) with a device that is able to provide the smart-lock 108 with data/information pertaining to the luminance or the level of brightness inside the room 102—this could also enable the smart-lock 108 to take into account the luminance or the level of brightness inside the room 102 when deciding whether or not (and possibly at what intensity/power) to turn on the light(s) of the room 102. Alternatively, if the smart-lock 108 is not able to acquire (be it using the interior LDR sensor 302, or from a capable device (which can for example include the wireless remote 114) that the smart-lock 108 may be connected to) measurements of the luminance or the level of brightness inside the room 102, then the smart-lock 108 can be configured to only attempt to turn on the light(s) of the room 102 during certain times (this may for example be during fix hours or during a period that can be intelligently adjusted (e.g., a period relating to sunset and sunrise)).

### Usage in a Smart Home Environment

In an embodiment, the smart-lock 108 can be connected (directly or through a hub) to the network 110 using the communication device 312 or 412. This can enable the smart-lock 108 to be part of a smart home environment. For example, should the smart-lock 108 be fitted or installed onto a bathroom's door, a user (in a different room) could query/ask a smart speaker (or a smart display) to find out whether the bathroom is vacant or occupied. Similarly, the user (in a different room) could ask the smart speaker (or smart display) to notify him/her when the bathroom becomes vacant. In such scenarios, the user's smart speaker (or smart display) could acquire the relevant information/data from the smart-lock 108 (and/or any capable device which can for example include the wireless remote 114) and inform the user accordingly.

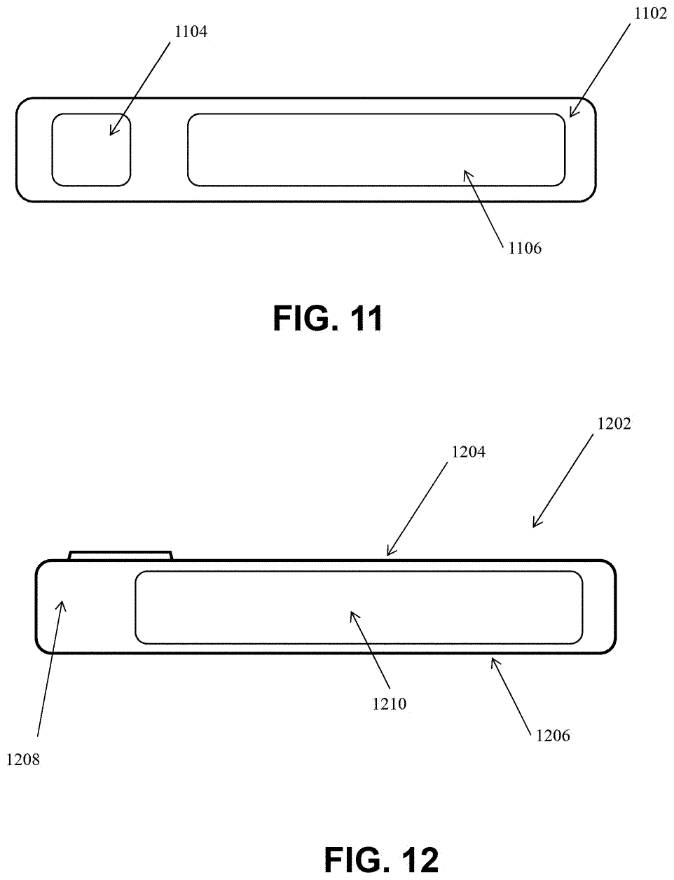

In an embodiment, any (one or more) button comprising the smart-lock 108 may be configurable to allow users to operate (or interact with) one or more device that the smart-lock 108 may be connected to. Such device may be directly (e.g., via a Bluetooth Low Energy ad-hoc connection) or indirectly (e.g., via a smart-home hub, or via a cloud service such as, for example, IFTTT by IFTTT Inc.) connected to the smart-lock 108. This mode of operating or interacting with a device (that the smart-lock 108 may be connected to) can for example be triggered by a short press, a long press, a multi press of such button, or any manner of pressing such button. For example, in an embodiment, a button comprising the exterior side 204 of the smart-lock 108 could be configured to trigger sound from a wireless door chime (which may be directly or indirectly connected to the smart-lock 108)—hence enabling the said button to act as a doorbell trigger/button. In the said example, the exterior side 204 of the smart-lock 108 can include a door handle 1102 (as shown in FIG. 11) having a solar panel 1106 (which can be used to power the smart-lock 108) as well as a button 1104 that can be configured to trigger/operate one or more connected device such as said wireless door chime.

### Reducing the Likelihood of Incorrectly Assessing the Occupancy Status of a Room

In an embodiment, one way in which the smart-lock 108 can deem/conclude that the room 102 has become vacant is by observing a period of time during which no motion/presence is detected (by the smart-lock 108 or any other device providing such information/data to the smart-lock 108) in the room 102. In an embodiment, the smart-lock 108 may comprise a means of determining/detecting whether the door 104 onto which it has been fitted is open or closed. Alternatively, the smart-lock 108 may acquire data/information regarding whether the door unto which it has been installed/fitted is open or closed from a device that it (i.e., the smart-lock 108) may be connected to—examples of such device include and is not limited to a door monitoring device (as disused as in the section of this document entitled “The door monitoring device”) and a smart door sensor. The smart-lock 108 being aware of whether the door unto which it is installed/fitted is open or closed can have many benefits. For example, the smart-lock 108 can be configured to only apply its locks (and/or indicate that the room 102 is occupied) when the smart-lock 108 detects that the door 104 onto which it has been installed is closed. Should the smart-lock 108 determine that the door 104 is closed when it detects motion in the room 102, then it may be useful for the smart-lock 108 to increase (as opposed to a scenario where the smart-lock 108 detects that its door 104 is open) the period of time (during which no motion can be detected by the smart-lock 108) that it (i.e., the smart-lock 108 or any other device providing data/information pertaining to any presence detected in the room 102 to the smart-lock 108) is to observe before assuming/concluding that the room 102 has become vacant. This may reduce the likelihood of the smart-lock 108 incorrectly assuming or concluding that the room 102 has become vacant. This method of reducing the likelihood of the smart-lock 108 incorrectly assuming or concluding that the room 102 has become vacant can work well if the room 102 has no other point of entry or exit (i.e., a door) as it would allow the smart-lock 108 to witness all entries and exits to/from the room 102. The said method may also work well when used in a room having more than one point of entry/exit should all points of entry/exit of the said room have installed onto them the proposed smart-lock 108. In such scenario, each smart-lock 108 installed on the doors of the said room could exchange data/information (for example, via a network using a wireless technology such as Bluetooth Low Energy) that could allow for better assumptions when determining the occupancy status of the said room.

In addition to the interior PIR sensor 304, the smart-lock 108 could connect to (via a wired or wireless connection) one or more other devices that are capable of detecting a presence inside the room 102. Examples of devices that could be used to detect a presence in the room 102 (and communicate pertaining data/information to the smart-lock 108) include and is not limited to a wired/wireless motion/presence detector (such as the wireless remote 114—as discussed in the section of this document entitled “The wireless remote”). One of the advantages of connecting the smart-lock 108 to a device (such as a wireless motion/presence detector) that can provide the smart-lock 108 with data/information pertaining to any presence detected in the room 102 is that it can allow for a reduction/elimination of blind spots. For the purpose of this document, a blind spot can be understood to mean any area of the room 102 that is not in the field of view of the smart-lock 108 (i.e., any area of the room 102 that is not in the field of view of any sensor (such as, for example, the interior PIR sensor 304) that is being used by the smart-lock 108 to detect the presence of any user inside the room 102) or any device (such as a wireless motion/presence detector) that may be connected to and providing the smart-lock 108 with data/information pertaining to any presence detected in the room 102). The ability to connect devices (i.e., a device that is configured to provide the smart-lock 108 with data/information pertaining to any presence detected in the room 102) to the smart-lock 108 may prove particularly advantageous in large rooms where the interior PIR sensor 304 alone may not be completely effective in detecting a presence/motion (this may for example due to a limited detection range). Hence, connecting the smart-lock 108 to one or more devices that are capable of detecting a presence in the room 102 may reduce the likelihood of the smart-lock 108 incorrectly concluding that the room 102 is vacant. Furthermore, in lieu of the interior PIR sensor 304, the smart-lock 108 can be configured to acquire data/information pertaining to any presence detected in the room 102 from any motion/presence detection device (such as the wireless remote 114) that it may be connected to.

### Methods of Detecting a Closed Door

This section of this document discusses various methods and sensors that could be used by the smart-lock 108 to detect/determine whether the door 104 (unto which the smart-lock 108 has been installed) is open or closed. Such sensor (or component) may be included on the smart-lock 108 or be included on a separate unit/apparatus that has the ability to communicate with the smart-lock 108. Any (one or a combination of more than one) of the technologies mentioned in this section of this document could be used by the smart-lock 108 to determine/detect whether the door 104 onto which it is installed is open or closed. Additionally, any suitable technology that is not mentioned in this section of this document can also be utilized by the smart-lock 108 to detect whether the door 104 is open or closed.

One method that the smart-lock 108 could use to determine whether the door 104 onto which it (i.e., the smart-lock 108) is installed is open or closed is by using a magnetic solution such as a magnetic/reed switch. For example, a magnetometer can comprise the smart-lock 108 for the purpose of detecting whether the door 104 is open or closed. In an embodiment, the smart-lock 108 can include a magnetometer on its interior side 202 as well as its exterior side 204—in such embodiment, the magnetometer comprising each side of the smart-lock 108 can be used (individually or together/in tandem) to derive whether the door 104 is open or closed. In using a magnetometer, the smart-lock 108 can for example be set (or use artificial intelligence) to understand the door 104 to be closed when magnetometer readings are within a certain range. In an embodiment, it may be useful for there to be a measurable/detectable magnetic force whilst the door 104 is closed—this magnetic force may for example be on the door frame of the door 104.

Another means by which the smart-lock 108 could determine whether the door 104 onto which it (i.e., the smart-lock 108) is installed is open or closed is by using a proximity sensor. A proximity sensor could for example be used to detect when it (i.e., the proximity sensor) is in close proximity to a given object (such as a door frame)—and this would indicate whether the door 104 is open or closed.

Other examples of sensors that could be used by the smart-lock 108 to determine whether the door 104 onto which it (i.e., the smart-lock 108) is installed is open or closed based on the distance it (said sensor) is from a given object (such as a door frame) include and is not limited to a Digital Distance Sensor, an Analogue Distance Sensor, a Time-of-flight sensor, a Laser Radar sensor (using Light Detection And Ranging (LIDAR) technology or LAser Detection And Ranging (LADAR) technology, or the like), or any combination thereof. Other examples of suitable technologies that could be used by the smart-lock 108 to determine whether the door 104 onto which it (i.e., the smart-lock 108) is installed is open or closed include and is not limited to a push switch (such as a push to break switch, or a push to make switch), a light sensor (such as a Light Dependent Resistor), an accelerometer, a microphone, an infrared sensor, a sonar sensor, an ultrasonic sensor, or any combination thereof. Alternatively, a mechanical solution could be used to determine whether the door 104 is open or close.

### Emergency Button

In an embodiment, the exterior side 204 of the smart-lock 108 may comprise a button that can be configured to function as an emergency button. The emergency button could be used by a user to trigger a means of opening (from outside the room 102) the smart-lock 108 in case of an emergency. Alternatively, or in addition to the said emergency button, the smart-lock 108 could be configured to retract its locks when an instruction to do so is received from a device (e.g., a Bluetooth Low Energy connected button, or a smartphone) that it may be connected to—this could likewise be used by a user to trigger the smart-lock 108 to retract its locks in case of emergency. A wireless button (such as a Bluetooth Low Energy button) can be configured to unlock the smart-lock 108 in case of emergency (by the pressing of said button)—this button can for example be placed outside the room 102 from where it can be pressed/operated.

### Automatic Unlocking in Case of Emergency

As previously discussed in the section of this documents entitled “Emergency button”, the smart-lock 108 can include a button on its exterior side 204 for opening the smart-lock 108 in case of emergency—this can be particularly useful should the room being guarded/secured by the smart-lock 108 be a bathroom or a washing closet. There currently exists devices such as some smart watches that can detect when a user has fallen and/or is in distress (e.g. having an unusual/abnormal heartbeat). In an embodiment, the smart-lock 108 can be configured to be operable by such device (e.g., a smart watch). For example, the smart-lock 108 could be configured to retract its locks upon receiving an instruction from a device such as a smart watch—this could for instance be due to the said device (e.g., a smart watch) detecting/estimating that a user who is inside the room 102 has fallen (and/or is in distress), this could be particularly useful should the room 102 be a bathroom, a washing closet, or a bedroom. This means of operating the smart-lock 108 can be useful in cases of emergency. As well as causing the smart-lock 108 to retract its locks, other actions such as alerting/notifying a person (and/or a company/entity) could also be invoked upon a user being deemed to be in distress and/or deemed to have fallen.

### Configuring the Smart-Lock Via a User Interface

In an embodiment, the smart-lock 108 can be configured by a user via a user interface—some examples of such interface will now be discussed. For the purpose of this document, an “administrator” can be described as a user who can configure/alter the settings of the smart-lock 108. An example of a means by which an administrator may manage/alter/configure the settings of the smart-lock 108 can be by using an application (such as a mobile application) having a graphical user interface—this could be a companion application for smart-lock 108 running on a computing device that can be configured to connect to and communicate with the smart-lock 108 (for the purpose of configuring the smart-lock 108). Another example of a means by which an administrator may manage/alter/configure the settings of the smart-lock 108 can be via a user interface which can be included on the smart-lock 108 (this may for example be accessed on the exterior display 406 or the interior display 314). Other examples of means via which an administrator may manage/alter/configure the settings of the smart-lock 108 include and is not limited to a web application, using audio commands (aimed directly at the smart-lock 108 or another device (such as a smart speaker) that the smart-lock 108 may be connected to), or via the user interface of a capable device (which can for example include the wireless remote 114) that the smart-lock 108 may be connected to. Examples of settings/configurations that an administrator may have the option of configuring for the smart-lock 108 include and is not limited to changing settings which affect the way/manner in which the smart-lock 108 applies or retracts its locks, pairing the smart-lock 108 to another device (such as a smart bulb, or the wireless remote 114), activating/deactivating manual unlocking and unlocking on the smart-lock 108, activating/deactivating automatic locking and unlocking on the smart-lock 108.

An administrator may also be provided with the option of configuring the emergency button that can be included on the exterior side 204 of the smart-lock 108. Settings relating to the emergency button that an administrator may be given the option to configure (via the companion application of the smart-lock 108 or otherwise) include and is not limited to activating the emergency button and deactivating the emergency button. The administrator may also have the option of configuring the manner in which the emergency button is to be invoked, this may for example include configuring how long is the emergency button to be held for (if a long press is implemented), and configuring whether/how any user inside the room 102 would be given the opportunity to respond when the emergency button is pressed whilst the room 102 is deemed occupied.

### Do not Disturb Mode

A “do not disturb” mode can be implemented on the smart-lock 108. In an embodiment, the interior side 202 of the smart-lock 108 may comprise a button (such as the toggle button 310) that can be configured to provide a means for users to activate (i.e., turn on) and deactivate (i.e., turn off/make inactive) do not disturb on the smart-lock 108. Once do not disturb mode is activated, the smart-lock 108 may display on its exterior side 204 (on for example (and not limited to) the exterior display 406) any combination of characters (such as letters and words), symbols, images, and colors that could be interpreted/understood by a user (such as a user who is outside the room 102) to mean that the user who inside is inside the room 102 does not wish to be disturbed. The toggle button 310 can be configured to perform one or more operations. Hence, a button configured for manually applying the locks of the smart-lock 108 can be the same button or be different from the button configured to operate do not disturb on the smart-lock 108. Alternatively, a user may activate do not disturb on the smart-lock 108 by pressing a button of a device that the smart-lock 108 may be connected to. Another means by which a user may activate and deactivate do not disturb on the smart-lock 108 is by orally expressing a command which can be captured by the microphone device 308 or by any capable device (such as, for example, a smart speaker or a smart display) that the smart-lock 108 may be connected to. In an embodiment, the smart-lock 108 can be configured to automatically apply its locks whenever do not disturb is activated by a user.

### The Virtual Knocker

This section discusses a device called the “virtual knocker”. The virtual knocker 112 can be configured to work together with a wired/wireless motion/presence detector (such as the wireless remote 114—as discussed in the section of this document entitled “The wireless remote”) and/or the smart-lock 108. Using the virtual knocker 112 for the purpose of displaying the occupancy status of the room 102 can provide an alternative to displaying the occupancy status of the room 102 on the exterior display 406.

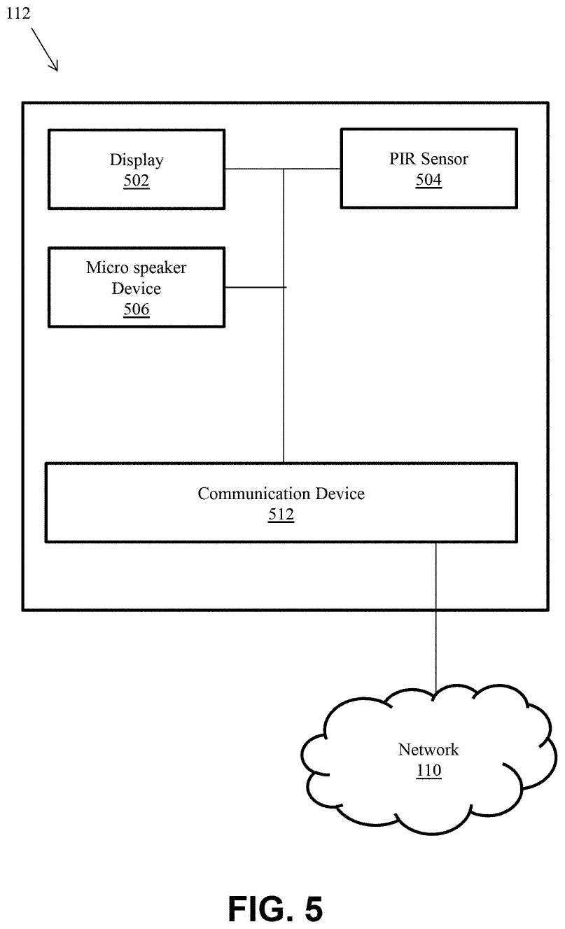

FIG. 5 shows the virtual knocker 112, in accordance with an embodiment of the smart-lock 108. In an embodiment, the virtual knocker 112 may comprise a display 502 (that can be configured to display the occupancy status of the room 102), a PIR sensor 504, a micro speaker device 506, and a communication device 512 (to allow for communication with other devices—such as the smart-lock 108 or a wireless motion/presence detector). The virtual knocker 112 is not required for the smart-lock 108 to function. The smart-lock 108 can function with or without the virtual knocker 112. The virtual knocker 112 can function with or without the smart-lock 108. The virtual knocker 112 is designed to be placed outside the room 102 (for example, on the door 104—outside the room 102) and can be configured to alert users of the occupancy status of the room 102 (as any user step in front of the virtual knocker 112). The virtual knocker 112 can be configured to acquire the occupancy status of the room 102 from a device (such as a wired/wireless motion/presence detector (e.g., the wireless remote 114) or from the smart-lock 108 (having an embodiment that includes a means of detecting a presence inside the room 102)) that can detect a user's presence in the room 102. Once the virtual knocker 112 has acquired the occupancy status of the room 102, it can be visually expressed on the virtual knocker 112 (on for example (and not limited to) the display 502 comprising the virtual knocker 112)—the occupancy status of the room 102 could be expressed with any combination of characters (such as letters and words), symbols, images, and colors that could be interpreted/understood by a user (such as a user who is outside the room 102) to signify the occupancy status (i.e., vacant or occupied) of the room 102. Alternatively, or additionally, the occupancy status of the room 102 can be expressed in an audible form. A micro speaker device (such as, for example, the micro speaker device 506) can for example output sound that could be interpreted/understood by a user to signify the occupancy status the room 102.

The virtual knocker 112 can make use of its PIR sensor 504 to conserve energy by only displaying the occupancy status of the room 102 whenever the presence of a user can be detected (e.g., using the PIR sensor 504). Alternatively, the virtual knocker 112 could be configured to constantly display the occupancy status of the room 102 regardless of whether or not the virtual knocker 112 can (or has the ability to) detect a presence. An e-paper display is an example of an energy efficient means of constantly displaying (regardless of whether or not the virtual knocker 112 can (or has the ability to) detect a presence) the occupancy status of the room 102. In an embodiment, the virtual knocker 112 can be configured to visually (on for example (and not limited to) the display 502 comprising the virtual knocker 112) and/or audibly (such as, for example, via the micro speaker device 506) express the lock status of the smart-lock 108. This feature could be used to notify users (such as a user who is outside the room 102) of the lock status of the smart-lock 108.

### The Wireless Remote

This section of the document discusses a device known throughout this document as the “wireless remote”. The wireless remote 114 is a device that is designed to be used inside the room 102 and can be configured to communicate (exchange messages and commands) with the smart-lock 108. The wireless remote 114 is a companion device for the smart-lock 108; however, the wireless remote 114 is not required for the smart-lock 108 to function. The smart-lock 108 can function with or without the wireless remote 114. Likewise, the wireless remote 114 can function with or without the smart-lock 108.

FIG. 6 shows the wireless remote 114, in accordance with an embodiment of the smart-lock 108. In an embodiment, the wireless remote 114 may comprise a display 602, a PIR sensor 604, an LDR sensor 606, a toggle button 608, a micro speaker device 610, and a communication device 612 (to allow for communication with other devices such as the smart-lock 108). The wireless remote 114 may comprise a toggle button 608 that can be configured to apply and retract the locks (i.e., locking and unlocking) of the smart-lock 108; the user can utilize the toggle button 608 to manually operate the smart-lock 108 (i.e., for locking and unlocking the door 104 of the room 102). Furthermore, the display 602 could be configured to display (amongst other things) the lock status of the smart-lock 108 (i.e., display whether the locks of the smart-lock 108 are applied or retracted)—this could be achieved through communication between the smart-lock 108 and the wireless remote 114.

In an embodiment, the smart-lock 108 can be configured to communicate its lock status to the wireless remote 114. The lock status of the smart-lock 108 could be visually expressed on the wireless remote 114 (on for example (and not limited to) the display 602 comprising the wireless remote 114)—the lock status could be expressed with any combination of characters (such as letters and words), symbols, images, and colors that could be interpreted/understood by a user (such as a user who is inside the room 102) to indicate the lock status of the smart-lock 108. Alternatively, or additionally, the lock status of the smart-lock 108 could be expressed in an audible form. A micro speaker device (such as, for example, the micro speaker device 610) can for example output sound that could be interpreted/understood by a user to mean that the smart-lock 108 has either applied its locks (i.e., the room 102 is locked) or that the locks of the smart-lock 108 have been retracted (i.e., the room 102 is unlocked). As the wireless remote 114 is able to detect the presence of a user (e.g., using the PIR sensor 604), it can be configured to perform the functions of a wireless presence/motion detector for the smart-lock 108 by communicating information/data pertaining to any presence detected inside the room 102 to the smart-lock 108—this is as discussed in the section of this document entitled “Reducing the likelihood of incorrectly assessing the occupancy status of a room”. This means that the wireless remote 114 can be configured to notify the smart-lock 108 whenever it (i.e., the wireless remote 114) detects a presence/motion in the room 102 and subsequently when a presence is no longer being detected in the room 102. And the smart-lock 108 can be configured to use information/data received from the wireless remote 114 (or any device capable of detecting a presence in the room 102) to perform actions such as automatically applying its locks (i.e., locking the room 102) and updating the exterior display 406 comprising the smart-lock 108 to show/display the occupancy status of the room 102.

As the wireless remote 114 can comprise a communication device 612 and a PIR sensor 604, it (i.e., the wireless remote 114) can be configured to control/operate other smart devices (such as the smart-lock 108, and/or a smart light bulb) based on the occupancy status of the room 102. Furthermore, when operating a smart light bulb, the wireless remote 114 can be configured to utilize the LDR sensor 606 to measure the luminance or level of brightness inside the room 102 when deciding whether or not to turn on the smart light bulb (and may also specify the level of intensity/power at which the light bulb should be turned on to). The wireless remote 114 can be configured to operate smart devices (such as a smart light bulb) by either communicating directly with such device(s), or via another smart device (such as the smart-lock 108) which would in-turn operate the relevant smart device(s). Additionally, when operating a smart light bulb, the wireless remote 114 can be configured to display the brightness level that is being outputted by the light bulb (i.e., display the level of brightness that is being outputted by the light bulb relative to its maximum brightness—this may for example be expressed as a percentage) on its display 602. It should also be noted that communication between the wireless remote 114 and the smart-lock 108 can occur over a wired or wireless connection.

### The Door Monitoring Device

A door monitoring device is a device that can be used to monitor a place (such as a room) for a presence. In an embodiment, the door monitoring device includes a means of detecting a presence inside a room (such as the room 102) as well as a means of detecting whether the door of the said room (such as the door 104 of the room 102) is open or closed. A key function of the door monitoring device is to monitor a place (such as the room 102) and detect any presence in the said place—this can for example be by detecting motion in the said place. The door monitoring device can determine/conclude that a room has become unoccupied following a period of time during which no movement/presence can be observed/detected in the said room. The door monitoring device can be mounted/fitted on a door (such as the door 104) or near the door of the room (such as, for example, on a door frame) that the door monitoring device is to monitor. The door monitoring device can also include a means of detecting when and how a door is being moved this can for example include detecting when the door is being opened or being closed. Examples of technologies that can comprise the door monitoring device for the purpose of detecting presence/movement includes and is not limited to a PIR sensor, an ultrasonic sensor, RADAR technology, or any combination of suitable technologies. Examples of technologies that can comprise the door monitoring device for the purpose of detecting when the door of the room it is to monitor is open or closed includes and is not limited to a Digital Distance Sensor, an Analogue Distance Sensor, a Time-of-flight sensor, RADAR technology, a magnetometer, a hall effect sensor or any combination of one or more suitable technologies. Furthermore, in an embodiment, the door monitoring device can include one or more suitable inertial motion sensor (such as an accelerometer, and/or a gyroscope) that can be configured to detect when the door unto which it is mounted/installed is moved for the purpose of automation—such automation can for example include automatically turning on the lights of the said room as a user opens, attempts to open, or moves the door of the said room.

The door monitoring device can be configured to automate tasks based on the occupancy status of a room—meaning performing tasks based on whether or not a presence is deemed to be inside the room being monitored by the door monitoring device. The door monitoring device can for example intelligently operate/control the illumination/lighting of a room (such as the room 102) or automatically trigger a locking system (such as the smart-lock 108) to apply its locks upon a presence being detected inside the room being monitored. Furthermore, the door monitoring device can further comprise sensors (or connect to a device that includes suitable sensors) that would enable the door monitoring device to intelligently control other devices—for instance, the door monitoring device can include a thermometer and/or a humidity sensor in order to intelligently control a bathroom fan. The door monitoring device can be a companion device to the smart-lock 108. The smart-lock 108 can however function independently of the door monitoring device as the door monitoring device is not required for the smart-lock 108 to function. Similarly, the door monitoring device can function independently of the smart-lock 108 as the smart-lock 108 is not required for the door monitoring device to function.

The ability of the door monitoring device to detect a closed door can be used as a means of reducing the likelihood of incorrectly deeming that a room (i.e., a room that is being monitored by the door monitoring device) has become unoccupied. Should the door monitoring device determine that the door of a room (i.e., the room being monitored by the door monitoring device) is closed whilst detecting a presence inside the said room—then it may be useful to extend the period of time (during which no presence/motion can be detected) that the door monitoring device is to observe before it can be concluded that the said room has become unoccupied (i.e., free of any presence), Hence, when a presence is detected inside a room whilst the door of the said room is deemed closed, it can be assumed with a high level of confidence that the said presence would remain inside the room until at least the next time the door of the said room is deemed opened (as this would allow the presence detected inside the said room to exit). In another example, the door monitoring device could be configured such that (upon a presence being detected inside the room that is being monitored whilst it is deemed that the door of the said room is closed) the period of time that it is to observe (during which no presence/motion can be detected) before it is to conclude that a room (i.e., the room that is being monitored) is no longer occupied would be elongated—this is in comparison to the duration of the observation had the door of the said room been deemed opened whilst the presence was detected.

The said method (involving the detection of a closed door) of reducing the likelihood of the door monitoring device incorrectly assuming/concluding that a room (which it is monitoring) has become vacant can be effective when the door being monitored is the sole logical entrance (i.e., the only door) to the room being monitored—as this would allow the door monitoring device to witness all entries and exits to and from the said room. Additionally, this method of reducing the likelihood of incorrectly predicting that a room has become vacant can also be effectively used in a room that has more than one point of entry/exit (such as more than one door)—this would be made possible by monitoring each point of entry/exit of the said room. In such scenario, to ensure that each point of entry/exit of the said room are monitored/witnessed—each door of the said room can be monitored by a door monitoring device or a device that is capable of detecting whether the door it is monitoring is open or closed. This would enable the system (comprising the door monitoring device and/or any device monitoring the said place/room) to detect when all points of entry/exit of the said room are closed whilst a presence/motion is detected inside the said room—thereby causing the period of time that is to be observed (during which no motion/presence is detected) before the said room can be deemed unoccupied to become adjusted accordingly.

### Safe Opening

This section of this document entitled “Safe opening” discusses the use of the smart-lock 108 to enhance child safety in places such as homes, and childcare venues (such as nurseries). There are currently products/devices on the market which are sometimes marketed as a “door lever lock”, “child proof door lever lock”, or the likes. Those devices are generally fitted on the exterior side of the door of a room (such as a bathroom, toilet, or kitchen), with the aim of stopping infants or other vulnerable persons from entering such room to avoid hazards. Such devices (e.g., a door lever lock) typically work by blocking the handle of the door lock securing the room—with a challenge (such as such as a manual trigger) being required to release the handle blocked by the said device: hereby allowing the door that is protected by said device to be opened. However, one potential problem with such device (such as a Door Lever Lock) is that a user (such as an adult) can become inadvertently locked inside the room whose entrance is being safeguarded by the said device and assistance from someone who is outside the said room may be needed to free a person stuck inside the room. Hence, such devices (such as those currently marketed as “child proof door lever lock”) may be dangerous as their design may result in a person becoming locked/blocked inside the room which they are safeguarding. In an embodiment, the smart-lock 108 can solve this problem with a feature called “safe opening”. Safe opening can be thought of as an implementation of child lock on the smart-lock 108—it can be used to safeguard the entrance to a room (such as the room 102). Note that the ideas, methods, and principles behind safe opening can also be applied to other child safety devices (such as for example a device to secure a medicine cabinet, or a device to secure a drawer)—with a safe opening challenge being required to allow access to a potentially hazardous thing or places.

In an embodiment, the smart-lock 108 can be configured to require users to complete a challenge (known as a “safe opening challenge”) before being allowed access to the room 102 (i.e., before the smart-lock 108 retracts its locks)—this is when safe opening is enabled on the smart-lock 108. Examples of safe opening challenges are later discussed. Note that the examples given are not limiting and do not exhaust all possible ways in which safe opening can be implemented. A safe opening challenge is a challenge/action/task that is to be successfully completed by a user before the smart-lock 108 allows him/her access to the room 102—this is whilst safe opening is enabled on the smart-lock 108. Having a user complete a safe opening challenge before the smart-lock 108 allows him/her access to a room (such as the room 102) can help prevent vulnerable people (such as infants) from accessing said room. Examples of challenges/actions/tasks that a user could be made to complete as part of a safe opening challenge will later be discussed—note that the examples that will be presented do not represent all possible challenges that a user could be presented with when trying to access a room (such as the room 102) whilst safe opening is enabled on the smart-lock 108.

A safe opening challenge can for example be configured, designed, created, selected, and/or enabled by a user (such as an administrator) of the smart-lock 108. Nothing in this document is intended to limit what can constitute a safe opening challenge or how it can be created/set-up. A safe opening challenge can be configured to meet the needs of users (such as an administrator, and members of a household) of the smart-lock 108. Hence, safe opening challenges can range in complexity. Once a safe opening challenge is enabled on the smart-lock 108 —safe opening is considered to be active/enabled on the smart-lock 108. Having safe opening enabled on the smart-lock 108 means that at least one safe opening challenge is enabled on the smart-lock 108—henceforth, a user attempting to enter the room 102 would be granted access to the room 102 once he/she has successfully completed a safe opening challenge that has been enabled on the smart-lock 108.

In an embodiment, the smart-lock 108 can be configured to accept one or more safe opening challenges. Should more than one safe opening challenge be configured/active/operational on the smart-lock 108, then the successful completion (upon attempt by a user) of any one of the safe opening challenges that have been configured may result in the smart-lock 108 retracting its locks (hereby allowing access to the room 102). For example, the smart-lock 108 can be configured so that successfully completing one safe opening challenge (such as pressing a button comprising the exterior side 204 of the smart-lock 108) or another safe opening challenge (such as pressing a button of a device that is connected to the smart-lock 108) can result in the smart-lock 108 retracting its locks. A key difference between “conditional access” (as discussed in the section of this document entitled “Conditional access”) and “safe opening” is that whilst the smart-lock 108 may attempt to authenticate/identify users when conditional access is active on the smart-lock 108, the smart-lock 108 would ordinarily not attempt to identify a person who is trying to access the room 102 whilst safe opening is enabled/active on the smart-lock 108. Rather, safe opening would allow anyone who is able to complete a safe opening challenge access to the room 102.

### Lock Status Whilst Safe Opening is Enabled

As previously discussed in the section of this document entitled “Automatic locking”, in an embodiment, the smart-lock 108 can be configured to automatically apply its locks (i.e., lock the door 104 of the room 102) based on the occupancy status of the room 102 (i.e., whether the room 102 is vacant or occupied)—this feature can be particularly useful when the room 102 is a bathroom, toilet, or any room where privacy may be desired. Furthermore, it has been discussed (in the section of this document entitled “Manual locking”) that the interior side 202 of the smart-lock 108 can include a button (such as, for example, the toggle button 310) which can be configured to manually apply the locks of the smart-lock 108 upon being pressed by a user who is inside the room 102—this feature can also be useful when the room 102 is a bathroom, toilet, or any room where privacy may be desired. Hence, the smart-lock 108 can have a lock status. In an embodiment of the smart-lock 108, the lock status of the smart-lock 108 can either be “locked”, “unlocked”, or “ready”—the meaning of “ready” as a lock status is later discussed.

Whilst safe opening is enabled, the smart-lock 108 can be configured so that a safe opening challenge is only ever presented (to a user who is trying to enter the room 102) when its lock status would have been considered to have been “unlocked” had safe opening not been enabled (i.e., when the lock status of the smart-lock 108 is “ready”). In other words, the smart-lock 108 can be configured so that no safe opening challenge is presented to a user whilst its lock status is “locked”. Alternatively, the smart-lock 108 can be configured so that successfully completing a safe opening challenge whilst its lock status is “locked” would not result in the retraction of its locks.

When safe opening is not enabled on the smart-lock 108—the smart-lock 108 can either have a lock status of “locked” (i.e., the locks of the smart-lock 108 are applied) or “unlocked” (i.e., the locks of the smart-lock 108 are retracted). However, whilst safe opening is enabled on the smart-lock 108, the smart-lock 108 can either have a lock status of “locked”. “unlocked”, or “ready”. Depending on the embodiment and configuration of the smart-lock 108, the smart-lock 108 may for example have a lock status of “locked” due to it (i.e., the smart-lock 108) having automatically applied its locks upon a user being detected inside the room 102, or a user (such as a user who is inside the room 102) having triggered (for example by pressing the toggle button 310) the smart-lock 108 to apply its locks.

The smart-lock 108 having a lock status of “ready” (whilst safe opening is enabled) means that the lock status of the smart-lock 108 would have been “unlocked” had safe opening been disabled/inactive on the smart-lock 108. Hence, the smart-lock 108 having a lock status of “ready” means that the smart-lock 108 has not become automatically (e.g., due to a presence being detected inside the room 102) or manually locked (e.g., by a user who is inside the room 102 purposefully pressing a button for the smart-lock 108 to apply its locks). The smart-lock 108 having a lock status of“ready” means that safe opening is enabled/active on the smart-lock 108. Furthermore, the smart-lock 108 having a lock status of“ready” means that the smart-lock 108 is locked to users who are outside the room 102 (i.e., locked to users who are on the exterior side 204 of the smart-lock 108) and can be unlocked by a user successfully completing a safe opening challenge. Hence, the lock status of the smart-lock 108 changes from “ready” to “unlocked” upon a user successfully completing a safe opening challenge.

Indicating when Safe Opening is Enabled

in an embodiment of the smart-lock 108, any combination of characters (such as letters and words), symbols, images, and colors that could be interpreted/understood by a user (such as a user who is inside the room 102) to indicate whether or not safe opening is active on the smart-lock 108 could be displayed on the exterior side 204 of the smart-lock 108 (on for example (and not limited to) the exterior display 406); alternatively or additionally, this could be expressed audibly via a micro speaker device (such as, for example, the micro speaker device 408). It has previously been discussed that the smart-lock 108 can be configured to communicates its lock status and/or the occupancy status of the room 102 to other devices (such as, for example, the virtual knocker 112)—hence, other devices (such as the virtual knocker 112) could be configured to visually and/or audibility communicate the lock status of the smart-lock 108 and/or the occupancy status of the room 102. In an embodiment, the smart-lock 108 can be configured to communicate whether safe opening is active/enabled to one or more devices (such as, for example, the virtual knocker 112) and the said device could communicate (visually, and/or audibly) this information (i.e., whether or not safe opening is enabled) to users (such as a user who is outside the room 102).

As previously discussed, whilst safe opening is disabled on the smart-lock 108, the lock status of the smart-lock 108 can either be “locked” or “unlocked”. However, whilst safe opening is enabled (on the smart-lock 108), the lock status of the smart-lock 108 can either be “locked”, “unlocked”, or “ready”. Hence, in communicating the safe opening status of the smart-lock 108, the lock status of the smart-lock 108 can also be implied/communicated. In an embodiment, the smart-lock 108 can have either one of three lock status: “locked”, “unlocked”, or “ready”. As previously stated, the lock status of the smart-lock 108 changes from “ready” to “unlocked” upon a user successfully completing a safe opening challenge. The smart-lock 108 having a lock status of “unlocked” (when a safe opening challenge has not just been (successfully) completed by a user) can suggest/imply that safe opening is not in operation (i.e., enabled) on the smart-lock 108, hence, no safe opening challenge is required to open the door 104—the door 104 of the room 102 can be opened as the locks of the smart-lock 108 are retracted whenever its lock status is “unlocked”. On the other hand, the smart-lock 108 having a lock status of “ready” can imply/signify that safe opening is enabled on the smart-lock 108 —hence, the locks of the smart-lock 108 are applied but can be unlocked/retracted upon a user successfully completing a safe opening challenge.

As previously discussed, the smart-lock 108 can be configured to express (visually and/or audibly) its lock status and/or the occupancy status of the room 102 on its exterior side 204 to notify users (such as any user who is outside the room 102) of its lock status and/or the occupancy status of the room 102. By communicating its lock status, the smart-lock 108 can also communicate/imply whether or not safe opening is enabled. This is because the smart-lock 108 can only have a lock status of “ready” whilst safe opening is active on the smart-lock 108. In an embodiment, the lock status of the smart-lock 108 can be visually expressed using any colors (which could for example be produced using an LED indicator, an illumination-capable button, an OLED display, or any other suitable technology) that can be understood to indicate the lock status of the smart-lock 108. For instance (noting that any colors could be used), red could be used to indicate that the lock status of the smart-lock 108 is “locked”, green could be used to indicate that the lock status of the smart-lock 108 is “unlocked”, and blue could be used to indicate that the lock status of the smart-lock 108 is “ready” and also imply/indicate that safe opening is enabled on the smart-lock 108. In another example, the same color that is used to indicate that the lock status of the smart-lock 108 is “unlocked” could be used to indicate that the lock status of the smart-lock 108 is “ready” but be presented in a different way for instance (noting that any colors could be used), a steady (non-flashing) green could be used to indicate that the lock status of the smart-lock 108 is “unlocked”; whilst a flashing/pulsing green could be used to indicate that the lock status of the smart-lock 108 is “ready”.

As previously discussed in the section of this document entitled “Virtual knock”—the smart-lock 108 can comprise a means of detecting when a user attempts to open the door 104 that it has been fitted on. The exterior side 204 of smart-lock 108 can include a door handle (or a doorknob) comprising a means of detecting when a user turns (or attempts to turn) the said door handle (or doorknob). Upon the smart-lock 108 detecting that a user has attempted (or is attempting) to turn the door handle (or door handle) comprising its exterior side 204; the smart-lock 108 could proceed by providing the said user cues (such as an audible cue and/or a visual cue) about how to open the door 104. A visual cue (such as, for example, the illumination of a button) and/or an audible cue (such as, for example, a beep, or a recorded voice) could be used to guide a user through a safe opening challenge. An example of an audio cue could be a recorded voice informing the user that safe opening is active on the smart-lock 108; this could be followed by a further cue (audio and/or visual) instructing the user on how to complete the safe opening challenge that is to cause the smart-lock 108 to retract its locks—an example of what such audio recording could be saying is: “Child lock is enabled; please hold the flashing button to unlock the door”. It should be noted that safe opening can be applied to (or implemented for) any smart/electronic locking device—this includes and is not limited to the smart-lock 108.

### Safe Opening Challenge Comprising a Button

One method by which a user can complete a safe opening challenge involves the pressing of a button. The said button can for example be included on the exterior side 204 of the smart-lock 108, or comprise a device that can be connected directly (e.g., using a wireless technology such as Bluetooth Low Energy (BLE)) or indirectly (e.g., through a smart home hub) to the smart-lock 108. Examples of devices that can include such button include and is not limited to the virtual knocker 112, and a wireless button (such as, for example, a BLE button) or any wired/wireless button that can be placed outside of the room for the purpose of being used as part of a safe opening challenge—such button could for example be mounted near the smart-lock 108 and outside the room 102 in a position that is outside the reach of a vulnerable person/persons (such as children). Should a device such as the virtual knocker 112 or a wireless button be connected to the smart-lock 108 for the purpose of allowing users to complete safe opening challenges; then it may be helpful/appropriate for such device to be placed at the entrance of the room 102 (such as, for example, on or near the door 104) and potentially out of the reach of the child/children being safeguarded (e.g., at a height that can be deemed to be out of the reach of the child/children being safeguarded).

In an embodiment of the smart-lock 108, a button that is comprising the exterior side 204 of the smart-lock 108 or a device that can be connected to the smart-lock 108 can be used by a user (who is outside the room 102) to perform a safe opening challenge. There is a plurality of ways in which a button can be pressed. In a safe opening challenge involving the pressing of a button, the challenge may involve pressing the button in a certain way—which can include and is not limited to pressing the button in any manner, a short press, a long press (can have a defined duration), a multi-press (pressing a button a certain number of times in a given time period or in quick succession), or any combination thereof.

When creating/configuring/setting up a safe opening challenge involving the pressing of a button, various levels of complexity can be reached by configuring how a button is to be pressed in completing the safe opening challenge. For instance, an example of a safe opening challenge with low complexity can involve a user pressing a button in any manner. Whilst another example of a safe opening challenge (with slightly more complexity than the latter) can involve a user pressing a button comprising the exterior side 204 of the smart-lock 108 using a long press, followed by a multi-press (such as a double press—meaning pressing the said button twice in short succession). Hence, in creating a safe opening challenge that includes the pressing of a button (be it one or more buttons); various levels of complexity can be achieved. This can be helpful as it gives users (such as an administrator) the option of selecting/creating/configuring/setting up a challenge that meets their complexity requirements (in terms of how difficult a safe opening challenge is to complete).

Using various methods such as color coding, and different ways of illuminating (such as being lit steadily, or blinking in a pattern (such as blinking rapidly, blinking slowly, pulsing, etc.)) a light source (such as an LED (Light Emitting Diode) indicator) can be configured to convey different meanings. In an embodiment, a light source (such as an LED light source) can be included on the exterior side 204 of the smart-lock 108 to convey/communicate information to users who are outside the room 102. For example, an LED light source can be configured to convey the occupancy status of the room 102, the lock status of the smart-lock 108, and/or convey whether or not safe opening is enabled/active on the smart-lock 108. An LED light source can also be included on any device (such as, for example, the virtual knocker 112, or a BLE button) that can be connected to the smart-lock 108 to convey information (such as the occupancy status of the room 102, the lock status of the smart-lock 108, and/or information regarding safe opening) to users who are outside the room 102. It may be energy efficient for such illumination to occur when a presence is detected (outside the room 102) to avoid wasting energy.

An illumination-capable button is a button that has the capability of being illuminated (often/typically includes an LED light source)—with such button being able to be wholly illuminated (meaning that the whole button can be illuminated) or partially illuminated (meaning only a part or some parts of the button can be illuminated). An illumination-capable button can serve two-fold. An illumination-capable button can convey/communicate information such as the occupancy status of the room 102, the lock status of the smart-lock 108, and/or convey whether or not safe opening is enabled/active on the smart-lock 108. And as a button, an illumination-capable button can also be configured to comprise a safe opening challenge—meaning that the pressing of an illumination-capable button can comprise a safe opening challenge. Be it on the exterior side 204 of the smart-lock 108 or on a device that the smart-lock 108 is connected to—an illumination-capable button can be configured to draw a user's attention to itself (i.e., the said button). For example, by illuminating and drawing attention to itself (i.e., the said button) whilst the lock status of the smart-lock 108 is “ready”, a user who aims to enter the room 102 (whilst safe opening is enabled) could more visibly notice/understand the need to press the said button before gaining access to the room 102 as such, using an illumination-capable button can make safe opening (and completing safe opening challenges) more intuitive than otherwise. Hence, illuminating a button can be an invitation to a user to complete/begin a safe opening challenge.

Illumination can also be helpful in guiding users through a safe opening challenge. For example, as part of a safe opening challenge, a user could be made to hold a said button until the button reacts (e.g., by flashing, becomes Illuminated, changes color, etc.). Alternatively, or additionally, sound (such as sound from the micro speaker device 408 or sound from any suitable/capable device (which can for example include the virtual knocker 112) that may be connected to the smart-lock 108) can be used to guide a user through a safe opening challenge—this can for example be by beeping, playing a sound, playing an audio recording of a voice, etc. in a bid to guide a user through a safe opening challenge. Hence, light (such as light from an illumination-capable button, or an LED indicator bulb) and/or sound can provide cues to a user when completing a safe opening challenge. In another example, an illumination-capable button and/or a sound cue can be used to guide a user as to when it is time to press a button (such as said illumination-capable button), and/or when it is time to release a button (such as said illumination-capable button) as the user attempts to complete a safe opening challenge.

Note that illumination near/around a button (such as a button that does not include its own light source) can have the same/similar benefits as an illumination-capable button; hence, illumination near/around a button (be it on the exterior side 204 of the smart-lock 108, or on a device that can be connected to the smart-lock 108) can be an effective way of drawing a user's attention.

Although this section of this documents talks of the “pressing” of a button; it should be recognized that there are different types of buttons. Hence, examples and methods involving the “pressing” a button apply to all types of buttons such as, for example, touch buttons. Furthermore, although LED technology is used in examples in this section of this document, note that any technology capable of illumination and/or rendering colors could instead be used such as, for example, an OLED (Organic Light-Emitting Diode), LCD (Liquid-Crystal Display), segmented LCD, and e-paper (with technologies such as e-Ink (by the E Ink Corporation) being capable of rendering colors).

Should a button for completing a safe opening challenge be included on a door handle; then a child could potentially attempt to make this button more reachable by pulling the said door handle towards them. To address this potential problem, the smart-lock 108 could be configured not to allow the completion of a safe opening challenge whilst a given door handle (such as any door handle included on its exterior side 204) is tilted to a certain extent. For this reason, one or more sensor such an accelerometer can comprise the smart-lock 108 to monitor a given door handle (such as a door handle included on the exterior side 204 of the smart-lock 108) in order to detect to what extent is the given door handle is tilted. Furthermore, the smart-lock 108 could be configured such that the detection of a tilted door handle can trigger/instigate one or more automatic action such as for example, turning a set of lights on (such as lighting that may be inside the room 102).

FIG. 10 shows a side view of an embodiment of a door handle which can comprise the exterior side 204 of the smart-lock 108. The said door handle includes a display 1002 (which can represent the exterior display 406), a button 1004 which itself includes an LED light source 1006. The button 1004 could be configured to allow users to complete safe opening challenges. Whilst the LED light source 1006 and the display 1002 (which can represent the exterior display 406) could be configured to communicated information to users, such as, for example, the lock status of the smart-lock 108, the occupancy status of the room 102, and/or communicate whether safe opening is in operation on the smart-lock 108. FIG. 10 represents a top view but could alternatively represent a front view of the said door handle.

### Safe Opening Challenge Comprising a Gesture

A gesture can comprise a safe opening challenge. In an embodiment, the exterior side 204 of smart-lock 108 can include a door handle (or a doorknob) comprising a touch panel (or any other device with the ability to detect gestures). Furthermore, any capable device (capable of detecting gestures) that can connect to the smart-lock 108 could potentially be configured to detect gestures (such as a sliding gesture) and communicate the outcome to the smart-lock 108. A user may for instance perform (be it on the smart-lock 108 itself or on a device that can be connected to the smart-lock 108) a sliding gesture (such as for example the “slide to unlock” gesture which is similarly used to unlock some smart-phones)—hence, a sliding gesture (and/or other types of gestures) can comprise a safe opening challenge. A sliding gesture could by itself be a safe opening challenge, or a sliding gesture could be used in conjunction with another action such as the pressing of a button to comprise a safe opening challenge.

Exempting a User from a Safe Opening Challenge

When safe opening is operational/active on the smart-lock 108, the smart-lock 108 having a lock status of “ready” can indicate that the room 102 is ready to be entered/used. For instance, should the room 102 be a bathroom, a lock status of “ready” could be indicative that the bathroom is vacant and ready to be entered/used—however, an action/event (such as a user successfully completing a safe opening challenge, or a user being made exempt from needing to complete a safe opening challenge) needs to occur before the smart-lock 108 unlocks/retracts its locks. This section of this document entitled “Exempting a user from a safe opening challenge” discusses the possibility of exempting a user from needing to perform/complete a safe opening challenge based on their characteristics (such as their height). Exempting some users from needing to perform a safe opening challenge can be a way of making safe opening more user friendly/seamless—it can reduce the burden of having safe opening enabled/operational on the smart-lock 108 for users who should/can be exempted.

Whilst safe opening is enabled on the smart-lock 108 (and whilst the lock status of the smart-lock 108 is “ready”), a user being exempted from doing a safe opening challenge means that he/she can open the door 104 without having to complete a safe opening challenge—with the smart-lock 108 retracting its locks (causing its lock status to become “unlocked”) upon the said user being exempted from doing a safe opening challenge. Should a user (who has been detected outside the room 102) not meet the criteria for receiving an exemption from doing a safe opening challenge—then the said user would need to successfully complete a safe opening challenge before being granted access to the room 102 (i.e., before the smart-lock 108 retracts its locks). Once a safe opening challenge is completed or a user is deemed exempt from doing a safe opening challenge—the lock status of the smart-lock 108 changes from “ready” to “unlocked”.

One method of deciding whether or not a user should be exempted from completing a safe opening challenge involves analyzing the said user as he/she is detected outside the room 102. A device can be configured to analyze a user against a criterion or a set of criteria as he/she is detected outside the room 102. One criterium that a user can be analyzed against in deciding whether he/she should be exempted (from completing a safe opening challenge) is the height of the said user, or whether the said user can reach a given height or a certain height level (which could be the threshold for being exempted). With the reasoning/assumption being that a user who is able to reach a certain height is unlikely to be an infant and can therefore be exempted from needing to complete a safe opening challenge in order to gain access to the room 102. This can be helpful as it can mean that someone (such as a house guest) who is not familiar with safe opening may experience seamless/easy entry into the room 102—even without them knowing that safe opening is in operation/active on the smart-lock 108. It should however be noted that exempting a user from needing to complete a safe opening challenge based on their height may not always be suitable. This is because not all vulnerable users can be said to be under a certain height. Whilst this method (based on a user's height, perceived height, or their ability to reach a certain height level) of deciding whether or not to exempt a user from needing to complete a safe opening challenge can be suitable when the aim is to prevent infants (i.e., children under a certain height) from entering the room 102 unaccompanied; it may not be suitable when the aim is to prevent taller vulnerable people such as taller children with learning difficulties (and adults with learning difficulties) from entering the room 102 unaccompanied.

In an embodiment, the smart-lock 108 can comprise a means of detecting/sensing information regarding the height of any user who is detected outside the room 102. Height related information that the smart-lock 108 can detect/sense (upon analyzing a user who has been detected outside the room 102) includes and is not limited to measuring/estimating/gauging the user's height, detecting if the user is at least a certain height, detecting if the user's height reaches a certain threshold or level (relative to how high the smart-lock 108 has been fitted/mounted), and detecting if the user can reach a certain height. Alternatively, or in addition, the smart-lock 108 can be configured to acquire information regarding the height of users detected outside the room 102 from another device. In an embodiment, the virtual knocker 112 can include a means of detecting/sensing information regarding the height of any user who is detected outside the room 102. Height related information that the virtual knocker 112 can detect/sense (upon analyzing a user who has been detected outside the room 102) includes and is not limited to measuring/estimating/gauging the user's height, detecting if the user is at least a certain height, detecting if the user's height reaches a certain threshold or level (relative to how high the virtual knocker 112 has been fitted/mounted), and detecting if the user can reach a certain height. Height related information that has been detected/sensed by the smart-lock 108 or acquired from any capable device (such as the virtual knocker 112) that the smart-lock 108 may be connected to can be used to decide whether or not a user should be exempted from needing to complete a safe opening challenge. The decision of whether or not a user (who has been detected outside the room 102) should be exempted from needing to complete a safe opening challenge can be taken by the smart-lock 108 or any device that the smart-lock 108 may be connected to.

Examples of technologies that can comprise a device (such as the smart-lock 108 or the virtual knocker 112) for the purpose of detecting/sensing/acquiring height related information (regarding any user that is detected outside the room 102) includes and is not limited to a proximity sensor, and a time-of-flight sensor. Even without measuring a person's height, the person could be exempted (from needing to complete a safe opening challenge) if he/she can be detected by the sensor that is to be used to test whether a person's height reaches a certain level. For instance, a user (such as, for example, an administrator) who is configuring/setting up safe opening on the smart-lock 108 could mount a device (such as, for example, the virtual knocker 112, or any device that can test a user's height) at around the height that they would like to set as the criterium/level for exempting users; thereafter, the said device being able to detect a user (at the mounted height) would indicate/suggest/entail that the said user meets the minimum height requirement for being exempted from needing to complete a safe opening challenge—hence, it may be helpful for the sensor used in the said device to have a relatively short detection range, an adjustable detection range, or have the ability to measure how far it is from a user detected (which could indicate the height or perceived height of the user relative to the position of the measuring device). For instance, if a device (i.e., a device for testing if a user's height reaches a certain level) is mounted at a height of one meter, then it can be assumed that a user is at least or around one meter tall if the said device is able to detect the said user (when the said device is set to have a low/short detection range)—hence, such user can be exempted from needing to complete a safe opening challenge on the grounds that they are likely a minimum of one meter tall or is around (perhaps slightly less, or slightly more with a margin of error) one meter of height.

Similarly, to exempting a user from needing to perform/complete a safe opening challenge based on their height—a wave (such as a hand wave gesture) can be used as a means to exempt users from needing to complete an alternative/different/additional safe opening challenge (such as, for example, the pressing of a button). Furthermore, a wave at a device can in itself constitute/be a safe opening challenge. A device that is able to detect a wave could for example be mounted at a height that can be deemed to be out of the reach of children. With the reasoning being that if a user is able to reach and wave at the said device (at the mounted height), then the said user is likely to be at least or around a certain height (which can be the height at which the device for detecting wave gestures has been mounted).

### Conditional Access

This section of this document entitled “Conditional access” discusses embodiments of the smart-lock 108 comprising a means of identifying users as they attempt to gain access to the room 102 (i.e., as users attempt to unlock the door 104 of the room 102). For discussions in this section of this document entitled “Conditional access”, unless the context dictates otherwise, it should be noted that when a user is said to attempt to retract the locks of the smart-lock 108, or when a user is said to attempt to unlock the door 104 of the room 102, or when a user is said to attempt to gain access to the room 102—it can be assumed that the user is operating the smart-lock 108 from outside the room 102. Furthermore, for discussions in this section of this document entitled “Conditional access”, it should be noted that when a user is said to attempt to retract the locks of the smart-lock 108 or a user is said to attempt to unlock the door 104 of the room 102, this can be understood as the said user attempting to gain access to the room 102. Conditional access on the smart-lock 108 will now be discussed in detail. It should be noted that conditional access can be applied to (or implemented for) any smart/electronic locking device—this includes and is not limited to the smart-lock 108.

In an embodiment, the smart-lock 108 can comprise a means of identifying a user as he/she attempts to unlock the door 104 of the room 102 (i.e., as they attempt to retract the locks of the smart-lock 108) from outside the room 102. In embodiment, the exterior side 204 of the smart-lock 108 may comprise a fingerprint reader that can be configured to identify users as they attempt to gain access to the room 102. Other methods/technologies that the smart-lock 108 may include (on its exterior side 204) for the purpose of identifying users as they attempt to unlock the door 104 of the room 102 (i.e., as they attempt to retract the locks of the smart-lock 108) include and is not limited to facial recognition technology, iris identification technology, voice identification technology, and palm identification technology. Alternatively, a user can identify themselves to the smart-lock 108 via a keypad or similar—the user may for example enter a Personal Identification Number (PIN), passcode, password, login, or the like. Alternatively, the smart-lock 108 may identify users using technologies such as Radio-Frequency Identification (RFID), Near Field Communication (NFC), or the likes.

Conditional access can be described as the process/action of the smart-lock 108 considering one or more conditions/factors when deciding the type of access that should be granted to a user attempting to gain access to the room 102. The smart-lock 108 may consider one or more conditions when applying/observing conditional access (i.e., when processing an attempt (from a user who is outside the room 102) to unlock the door 104 of the room 102 whilst conditional access is active on the smart-lock 108)—such condition is known as a condition of access. A condition of access is a condition that is to be tested for (i.e., to be established to be met or not met) as the smart-lock 108 calculates/derives the type of access that is to be granted to a user attempting to retract the locks of the smart-lock 108 (i.e., as a user attempts to gain access to the room 102) whilst conditional access is active. Examples of conditions of access (i.e., factors that are to be taken into account as the smart-lock 108 calculates the type of access that should be granted to a user who is trying to retract its locks) can include and is not limited to the occupancy status of the room 102 (i.e., whether the room 102 is vacant or occupied), the time (i.e., the time at which the user is attempting to unlock the door 104 of the room 102), and the date (i.e., the date on which the user is attempting to unlock the door 104 of the room 102).

In an embodiment, the smart-lock 108 can be configured to utilize a conditional access rule to process attempts to access the room 102. A conditional access rule can comprise data/elements that can be used by the smart-lock 108 when calculating/deriving the type of access (be it instant access, delayed access, denied access or otherwise) that should be granted to any user attempting to gain access to the room 102 (i.e., any user who attempt to retract the locks of the smart-lock 108 from outside the room 102) whilst conditional access is active on the smart-lock 108. A conditional access rule can be stored in the memory of the smart-lock 108, or stored in a location (such as the Internet/Cloud) from where the smart-lock 108 can utilize it (i.e., the conditional access rule) when conditional access is active, or be stored in the memory of any capable device that the smart-lock 108 may be directly/indirectly connected to. The conditions/condition of access to a room (such as the room 102) can be included in a conditional access rule. A conditional access rule can be configured to apply to a user, a set of users, a group, or any combination thereof. A conditional access rule may comprise a user's credentials—users' credentials can be used by the smart-lock 108 to ascertain who a conditional access rule (or a condition of access) applies to. Otherwise, a conditional access rule may comprise an alternative means of linking the appropriate user/users (as selected by an administrator when creating/amending the conditional access rule) to itself (i.e., the conditional access rule)—such alternative includes and is not limited to a foreign key linking the credentials (such as biometric data, or a passcode) of the appropriate/corresponding user/users to the conditional access rule.

Note that a conditional access rule can be configured to apply to everyone (with or without exception) that can be identified by the smart-lock 108. Furthermore, a conditional access rule can also be configured to apply to everyone (with or without exception) regardless of whether or not a user/users can be identified by the smart-lock 108. A simple example of a conditional access rule that an administrator may wish to create to affect/apply to everyone (regardless of whether or not a user/users can be identified by the smart-lock 108) is one in which the smart-lock 108 is set to deny all users access to the room 102 whenever the room 102 is deemed occupied—this conditional access rule may for example be suitable in a scenario where the room 102 is a bathroom/toilet; in this scenario, the smart-lock 108 may not need to identify (or attempt to identify) users.

Whilst conditional access is active, the smart-lock 108 can process attempts to retract its locks by identifying (or attempting to identify) any user who tries to retract its locks and ascertain the type of access that should be granted to the said user. In processing an attempt (from a user who is outside the room 102) to retract the locks of the smart-lock 108 (whilst conditional access is active), the smart-lock 108 may arrive at the following conclusions/decision (this is non-exhaustive): grant the user “denied access”—access is denied to the user (i.e., the smart-lock 108 refuses to unlock the door 104 of the room 102), grant the user “instant access” (i.e., the smart-lock 108 instantly unlocks the door 104 of the room 102), or grant the user “delayed access” (i.e., the smart-lock 108 begins a countdown (for a defined duration) after which it (i.e., the smart-lock 108) is to unlock the door 104 of the room 102—the possibility of interrupting a delayed access countdown/waiting time is later discussed).

A user's credentials can be used by the smart-lock 108 to identity the said user. Examples of credentials that can be used by the smart-lock 108 to identify a user include and is not limited to biometric data (such as data which can be used for fingerprint recognition, or data which can be used for facial recognition), RFID/NFC data, a user/authentication token, and a passcode. In an embodiment, the smart-lock 108 can identify a user once the credentials of that user are added to the memory of the smart-lock 108, or stored in a location (such as the Internet or on any capable device that the smart-lock 108 may be connected to) from where the smart-lock 108 can utilize said credentials, or a device that can authenticate/identify users for the smart-lock 108.

### Configuring Conditional Access

As previously discussed in the section of this document entitled “Configuring the smart-lock via a user interface”—the smart-lock 108 can be configured by an administrator via a user interface. Via a user interface, an administrator may have the option of creating/composing and amending a conditional access rule; an administrator may also have the option of enabling, disabling and deleting a conditional access rule. Conditional access can be said to be active on the smart-lock 108 when at least one conditional active rule is enabled/active on the smart-lock 108 (i.e., when at least on one conditional active rule is being observed/executed by the smart-lock 108). Once an administrator has created and enabled/activated a conditional access rule, the smart-lock 108 can utilize it (i.e., the conditional access rule created by the administrator) to process attempts to gain access to the room 102 and grant each user the type of access that is in accordance with the said conditional access rule. Note that the smart-lock 108 may include/observe/adhere to more than one conditional access rule at the same time.

A conditional access rule can comprise one or more conditions of access upon which a said user should be granted a particular type of access. When creating or amending a conditional access rule, an administrator can specify one or more conditions (i.e., conditions of access) under which a said user/users should be granted a particular type of access (e.g., instant access, delayed access, or denied access); the administrator may also specify exceptions such as an alternative type of access that is to be granted to a said user should certain conditions or a certain condition be met. A conditional access rule may comprise one or more exceptions. Furthermore, a conditional access rule can include (i.e., apply to) one person, more than one person, one group, more than one group, or any combination thereof. The persons included in a conditional access rule may have different types of access depending on how the conditional access rule has been configured—for example, when a condition is met, an administrator may opt to grant a said user instant access to the room 102 whilst giving another user delayed access to the room 102.

An example of a means by which an administrator may configure the smart-lock 108 is via a mobile application running on a smartphone that can be connected to the smart-lock 108. An administrator could for example use a mobile application running on a smartphone to create and amend a conditional access rule. Settings/configurations relating to conditional access that an administrator may configure for the smart-lock 108 include and is not limited to adding (or initializing the process of adding) a user' credentials (such as authentication codes, or biometric data (e.g., data for fingerprints, and data for facial recognition)) to the memory of the smart-lock 108 (or otherwise) to allow the smart-lock 108 to identify users using their credentials, removing a user's credentials. Other settings/configurations relating to conditional access that an administrator may configure for the smart-lock 108 include and is not limited to setting conditions for delayed access, setting conditions for instant access, setting conditions for when access is to be denied, and selecting who (be it a single user, multiple users, a group of users, everyone, or otherwise) a conditional access rule applies to and the specifying any condition/conditions under which a user should be granted a specific type of access.

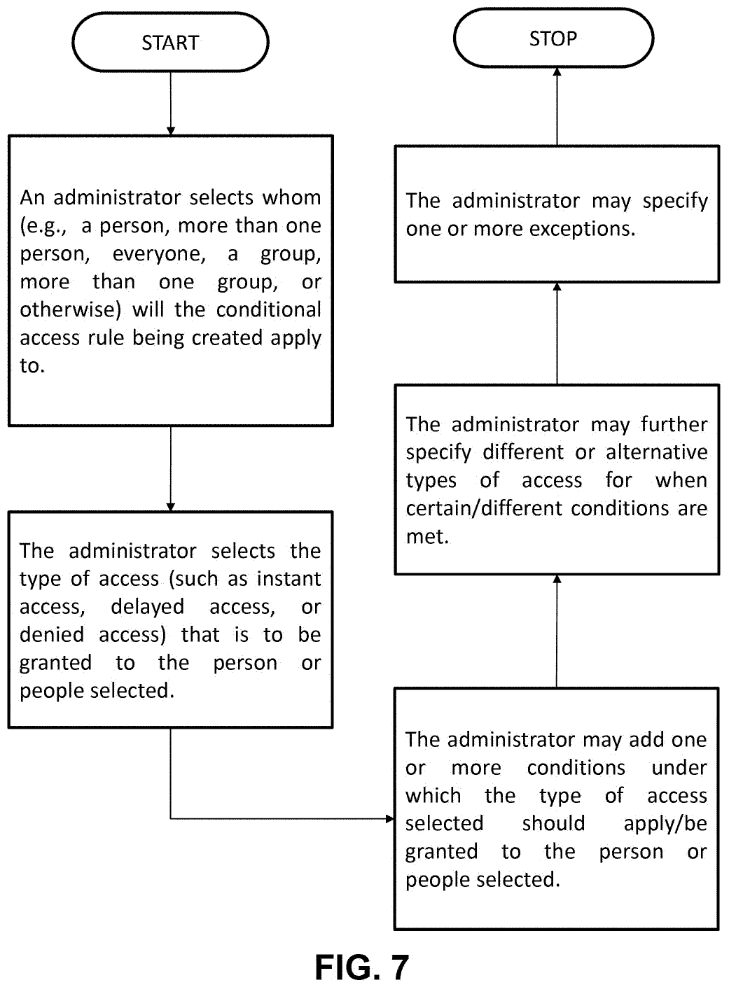

As previously discussed in the section of this document entitled “Do not disturb mode”, a do not disturb mode can be configured on the smart-lock 108. When creating a conditional access rule, an administrator may specify if and how having do not disturb activated should affect the type of access that is to be granted to one or more users. Hence, whether or not “do not disturb” is active on the smart-lock 108 can be a condition of access. For example, when creating a conditional access rule, an administrator could specify that a certain user should be granted instant access (to the room 102) should do not disturb be inactive (i.e., turned off), the administrator may also specify a different type of access (such as delayed access, or denied access) for that user for when do not disturb is active (i.e., turned on) on the smart-lock 108. The elements that can be included in a conditional access rule (such as users' credentials, condition(s) of access, and the type of access that is to be granted) can be introduced/inserted into the smart-lock 108 by an administrator in any order. Likewise, when a user attempts to retract the locks of the smart-lock 108 (whilst conditional access is active), the smart-lock 108 can consider/process/analyze the elements included in the corresponding/related conditional access rule/rules in any order. FIG. 7 shows an example of a method comprising different steps by which an administrator can create/compose a conditional access rule. It should however be noted that the order in which steps are shown in FIG. 7 is not definitive, hence, the steps shown in FIG. 7 can be taken in a different order, A person ordinarily skilled in the arts would also understand that the steps shown in FIG. 7 can be amended or omitted

### Delayed Access

A delayed access countdown (which can also be called the countdown of a delayed access, or the countdown for delayed access) is the amount of time that is to expire/pass/elapse before the smart-lock 108 automatically retracts its locks (i.e., unlock the door 104 of the room 102) upon delayed access being granted to a user. The smart-lock 108 granting a user delayed access means that the said user is to wait a certain amount of time before it (i.e., the smart-lock 108) automatically retracts its locks. The amount of time that a user is (or a set of users are) to wait (i.e., the duration of a delayed access countdown) whenever a certain condition (i.e., a condition of access) or a set of conditions are met can be set by an administrator when creating or amending a conditional access rule. The exterior display 406 (which can be included on the smart-lock 108) can be configured to display a delayed access countdown in real-time to allow any user who is outside the room 102 to anticipate when the countdown will conclude. Else the waiting time can be expressed in any suitable visual and/or audible manner outside the room 102—be it on the exterior side 204 of the smart-lock 108 or via another device such as the virtual knocker 112.

Once the smart-lock 108 grants delayed access to a user who is outside the room 102 (i.e., once the smart-lock 108 begins counting down the time that the user is to wait before it (i.e., the smart-lock 108) is to automatically retract its locks), the delayed access granted by the smart-lock 108 can be cancelled/revoked by another user (such as a user who is inside the room 102). The smart-lock 108 can for example alert/notify any user that is inside the room 102 that delayed access has been granted to a user who is outside the room 102—this notification can be audible and/or visual (the notification can for example be displayed on the interior display 314 (which can be included on the smart-lock 108) or the display 602 (which can be included on the wireless remote 114).

Once delayed access has been granted to a user who is outside the room 102 (and before the countdown for delayed access concludes with the smart-lock 108 automatically retracting its locks), another user (such as a user who is inside the room 102) can be given an opportunity to respond. Examples of ways in which a first user (such as a user who is inside the room 102) can respond to another user (i.e., a user who is trying to gain access to the room 102) being granted delayed access to the room 102 include and is not limited to the first user (who is inside the room 102) performing an action that would result in the annulment of the delayed access granted to the user who is outside the room 102 (thereby causing the delayed access countdown to end without the smart-lock 108 retracting its locks), or the first user (who is inside the room 102) performing an action that would result in the hastening/premature conclusion of the delayed access countdown—thereby giving the user who is outside the room 102 instant/earlier access to the room 102 due to the action performed by the first user (who is inside the room 102). Examples of ways in which a first user (who is inside the room 102) can cancel/annul a delayed access granted by the smart-lock 108 to a user attempting to gain access to the room 102 (e.g., by attempting to retract the locks of the smart-lock 108) include and is not limited to the first user (who is inside the room 102) pressing a button which can be included on the interior side 202 of the smart-lock 108, the first user pressing a button which can be included on the wireless remote 114, or the first user orally expressing a command to cancel/annul the delayed access granted (this command can for example be processed by the smart-lock 108 or a smart device (such as a smart speaker, or a smart display) that may be connected to the smart-lock 108) by the smart-lock 108 to the user attempting to retract the locks of the smart-lock 108 (i.e., the user who is trying to gain access to the room 102).

Examples of ways in which a first user (who is inside the room 102) can intervene to hasten/prematurely conclude the countdown of a delayed access granted by the smart-lock 108 to a user attempting to gain access to the room 102 include and is not limited to the first user (i.e., the user who is inside the room 102) pressing a button which can be included on the interior side 202 of the smart-lock 108, the first user pressing a button which can be included on the wireless remote 114, or the first user orally expressing a command to hasten/prematurely conclude the countdown of the delayed access granted (this command can for example be processed by the smart-lock 108 or a smart device (such as a smart speaker, or a smart display) that may be connected to the smart-lock 108) by the smart-lock 108 to the user attempting to retract the locks of the smart-lock 108 (i.e., the user who is trying to gain access to the room 102).

Alternatively, a first user (such as a user who is inside the room 102) could respond in a way that would elongate the delayed access countdown (i.e., increase the amount of time that the user who is trying to gain access to the room 102 is to wait before the smart-lock 108 automatically retracts its locks). Should a first user (such as a user who is inside the room 102) choose not to respond to a notification that another user (i.e., the user who is trying to gain access to the room 102) has been granted delayed access, then the smart-lock 108 would automatically retract its locks once the delayed access countdown has concluded/elapsed.

It should be noted that any user could respond to a notification triggered when someone (i.e., a user who is trying to retract the locks of the smart-lock 108 whilst conditional access is active/enabled) is granted delayed access to the room 102 as long as he/she (i.e., the user who is to respond to the notification) is able to interface/communicate with the smart-lock 108. Hence, it is not only a user who is inside the room 102 who can respond to a notification that delayed access has been granted (or is being granted) to a user who is attempting to gain access to the room 102 (e.g., by attempting to retract the locks of the smart-lock 108). Examples of means/medium via which a user may respond to a notification from the smart-lock 108 (such as a notification pertaining to a user being granted delayed access to the room 102) include and is not limited to interfacing with the smart-lock 108 via a smartphone application, a web application, the Internet/Cloud, pressing a button (such as the toggle button 310) that is included on the interior side 202 of the smart-lock 108, or pressing a button that is included on any capable device (which can for example include the wireless remote 114) that the smart-lock 108 may be connected to.

### Exit Screening

As previously discussed, conditional access involves the smart-lock 108 screening users as they attempt to gain access to the room 102 (e.g., by attempting to retract the locks of the smart-lock 108) in order to ascertain the type of access that should be granted at each attempt. In a similar manner, “exit screening” would involve the smart-lock 108 screening users as they attempt to exit the room 102 (i.e., screen users who attempt to retract the locks of the smart-lock 108 from inside the room 102). Hence, in an embodiment, the smart-lock 108 may comprise one or more means of identifying users on its interior side 202 this can enable the smart-lock 108 to identify users as they attempt to retract its locks from inside the room 102 (i.e., as users attempt to exit the room 102). Exit screening may for instance be useful in a scenario where easy exit from a building/house/room (such as the room 102) is desired but there exists a need to restrict exit for one or more users—this may for example be for security reasons in a nursery, a hospital, or for use in a house with one or more infants or vulnerable people.

### The Biometric Door Handle

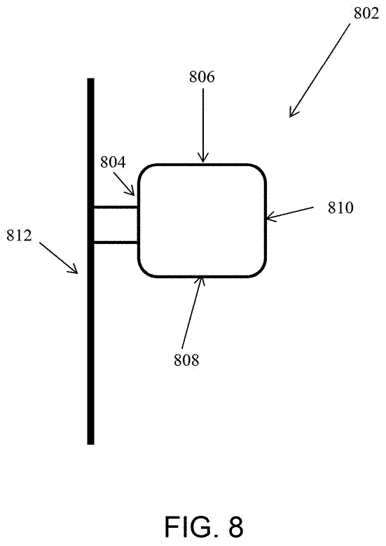

This section of this document discusses an innovative door handle referred to as a “biometric door handle”—an embodiment of the biometric door handle 802 is shown in FIG. 8. In an embodiment, the biometric door handle 802 can be included in a locking system such as the smart-lock 108. The biometric door handle 802 is designed to allow users to easily identify themselves to a locking system as such, for example, the smart-lock 108. In an embodiment, the biometric door handle 802 can be included on the exterior side 204 of the smart-lock 108 for the purpose of identifying users as they attempt to enter the room 102.

Throughout this document, references to palm prints includes the palm prints, as well as any area of the hand (having epidermal ridges, valleys, and/or any other features that can be unique to a person) that may come in contact with any sensor that is comprising the biometric door handle 802 for the purpose of identifying users. Hence, references to palm prints may also include prints/images of certain parts of the finger—such as, for example, the lower parts of fingers on a hand (which is nearer to the palm) as well as prints/images of any part of the hand (including fingerprints) that could be used to identify a user.

The biometric door handle 802 includes at least one sensor/technology for identifying users. In an embodiment, the size and/or the position of at least one the sensors for identifying users is such that a user's palm prints would likely come in contact with at least one of the said sensors when attempting to turn the biometric door handle 802. Any sensor (be it one or more sensor) which can be included on the biometric door handle 802 for the purpose of identifying users can be configured to automatically attempt to identify a user as his/her hand comes in contact with or approaches the said sensor/sensors—this can for example be as a user attempts to turn the biometric door handle 802 in a bid to open the door of a room (such as the door 104 of the room 102).

Technologies that can be used for fingerprint identification can also be adapted for use in the identification of palm prints on the biometric door handle 802—allowing for the imaging and processing of the part/portion/region of any hand that comes into contact with at least one imaging sensor that is comprising the biometric door handle 802 (for the purpose of imaging a user's palm prints) as the said user attempts to touch/turn the biometric door handle 802. There are multiple technologies that are currently on the market that allow for finger identification—such technologies include and is not limited to vein detection/imaging technology, feature extraction, feature matching, extraction of minutiae features, minutiae points-based identification, etc. Furthermore, the types of scanners and sensors that can be used for fingerprint imaging can also be adapted (e.g., to be able to capture a larger surface area) to capture palm prints—these include and is not limited to optical scanners, thermal scanners, capacitive scanners, tactile scanners, and the use of charge-coupled device (CCD) imaging technology. In an embodiment, the biometric door handle 802 can include one or more imaging sensor that allows for identification of palm prints without the need for physical contact (i.e., using touchless palm verification technology)—this may be in lieu of or in addition to another type of imaging sensor. Any combination of technologies for capturing/imaging and processing palm prints can be included on the biometric door handle 802.

In an embodiment, at least one sensor included on the biometric door handle 802 for the purpose of capturing/imaging palm prints should be able to capture a portion of a user's hand that is sufficiently large enough to be used to identify the said user. In an embodiment, the biometric door handle 802 can include more than one sensor for capturing palm prints. Should the biometric door handle 802 include more than one sensor for capturing palm prints, then it may be useful for each sensor to be strategically positioned in a manner that would allow for different parts of the hand (such as parts of the palm, and fingers) to be captured. Once a user's palm is captured, the image captured by each sensor can be compared with existing/stored biometric records in a bid to identify the user whose palm has just been captured. The biometric door handle 802 and/or the smart-lock 108 could be configured in a way that a positive match from any one of the imaging sensors may be enough to validate a user's identity. Further stipulations can however be configured, such as, for example, a requirement that all positive matches (from any of the imaging sensors) be pertaining to the same person (whose biometric record matches the newly captured palm prints) in order for a user's identity to be confirmed as the said person (whose biometric record matches the newly captured palm prints).

A user can become known/recognizable once his/her palm prints are captured and recorded/stored. The sensor or sensors that are included on the biometric door handle 802 for the purpose of capturing palm prints can be used to capture a user's palm prints so that the resulting biometric data can be associated with the record of the said user. Once a user's palm prints have been captured, they can then be stored—this can for example be on a memory unit which is included on the smart-lock 108, a memory unit that is included on the biometric door handle 802, or any other memory unit or device that can be accessed when comparing stored/existing records with any palm prints captured in a bid to identify/verify a user. Once a user's palm prints are captured and recorded (i.e., once a user's biometric data becomes a stored record), the said user's identity can then be confirmed/verified whenever he/she attempts to touch/turn the biometric door handle 802. The biometric door handle 802 would process any touching/turning attempts by capturing any portion of the hand of the user (who is attempting to turn the biometric door handle 802) that it (i.e., any sensor that is comprising the biometric door handle 802 for the purpose of identifying users) has come in contact with, and proceed by attempting to match the newly captured palm prints (from the said user's attempt to touch/turn the biometric door handle 802) with a stored record.

Once a user's palm is captured by the biometric door handle 802 (which may for example be triggered as a result of the said user attempting to touch or turn the biometric door handle 802), there can then be an attempt to compare the newly captured palm prints with stored records in an attempt to test whether the newly captured palm prints can be matched with the stored record of a known user or otherwise. And should conditional access be in operation, then the said user would be granted the appropriate type of access—be it instant access, delayed access, or denied access upon their palm prints being matched with a stored record or otherwise,

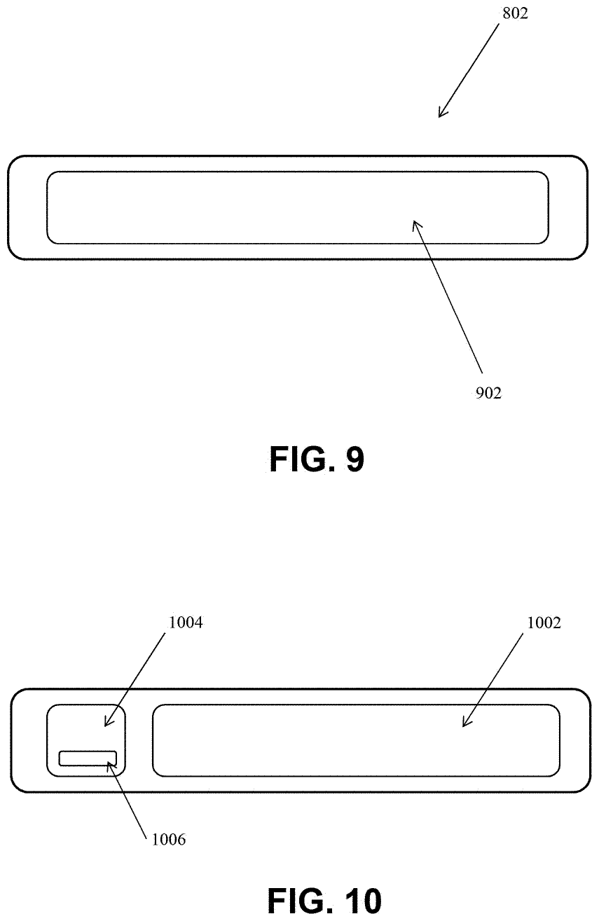

FIG. 8 shows aside view of an embodiment of the biometric door handle 802 mounted on a door 812 (which can also represent the door 104 of the room 102), having a front side 810, a back side 804, a top side 806, and a bottom side 808. In an embodiment, the biometric door handle 802 includes an imaging sensor (for capturing palm prints) on its top side 806, its back side 804, its front side 810, and its bottom side 808. FIG. 9 shows an imaging sensor 902 (for capturing palm prints) included on the top side 806 of the biometric door handle 802, the said imaging sensor 902 is wide in design to allow for a wide area of the palm to be captured. Having a large imaging sensor (such as the imaging sensor 902 depicted in FIG. 9) can allow for a large portion of a user's hand to be captured—hence, any imaging sensor included on other sides (such as, the back side 804, the front side 810, and the bottom side 808 of the biometric door handle 802) of the biometric door handle 802 can also be designed to allow for a large surface area to be captured.

Note that in an alternative embodiment, the biometric door handle 802 can have a different form to the one depicted in FIG. 8. For instance, in an embodiment, the biometric door handle 802 could have a circular shape and include one or more imaging sensor (for identifying users) around/within that shape. Hence, the biometric door handle 802 can have any shape/form—including the shape of a doorknob).

In an embodiment, the exterior display 406 comprising the exterior side 204 of the smart-lock 108 can include an in-display sensor for imaging/capturing palm prints. Hence, in an embodiment, the imaging sensor 902 shown in FIG. 9 can represent a display (which can for example be the exterior display 406) which includes a sensor for imaging palm prints.

As previously discussed in the section of this documents entitled “Emergency button”, the smart-lock 108 can include a button on its exterior side 204 for opening the smart-lock 108 in cases of emergency—this can be particularly useful should the room 102 being guarded/secured by the smart-lock 108 be a bathroom or a washing closet. Whist it has also been discussed (in the section of this documents entitled “Configuring the smart-lock via a user interface”) that the smart-lock 108 can be configured to open upon a long press of the emergency button. In an embodiment, the exterior side 204 of the smart-lock 108 can include a means of detecting who is pressing the emergency button—as such, the smart-lock 108 could for example be configurable to instantly unlock for a given person/persons (such as members of a household) but required unknown users to long-press the emergency button before unlocking. Hence, conditional access can be configurable on the emergency button that can be included on the exterior side 204 of the smart-lock 108. One means by which the smart-lock 108 could attempt to identify who is pressing (or has pressed) the emergency button is by including a biometric door handle 802 on its exterior side 204 or by including a biometric sensor (such as a fingerprint imaging sensor) on the emergency button.

### Door Handle for Left-Handed and Right-Handed Doors

This section of this document entitled “Door handle for left-handed and right-handed doors” discuses door handles that can be mounted on both left-handed and right-handed doors. Throughout this document, when a door handle (such as the door handle 1202, and the biometric door handle 802) is said to be mounted/installed on a door, it is assumed/implied that the said door handle is included on an embodiment of the smart-lock 108 and that it is the smart-lock 108 that is mounted/fitted onto the said door. Having door handles whereby the top side and the bottom side of each door handle (i.e., the top and the bottom side of both the interior door handle and the exterior door handle) look identical or similar can be advantageous as it can allow consumers to purchase and install a door lock without having to consider whether it will be installed on a left-handed or a right-handed door. In an embodiment, the smart-lock 108 can include door handles that allow for mounting on both left-handed doors and right-handed doors. The design of each door handle can be such that a user would have the same (or a similar) experience regardless of whether the door onto which the door handles are mounted is left-handed or right-handed. Hence, the functions/features that are available to users would be the same regardless of whether the door onto which the said door handles are mounted is left-handed or right-handed.

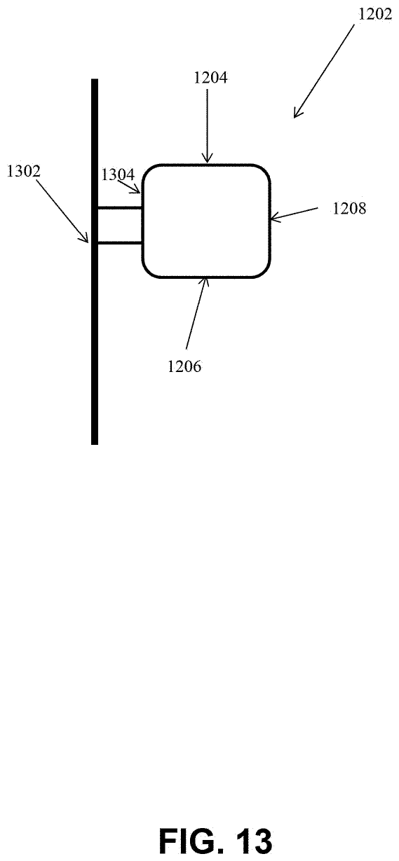

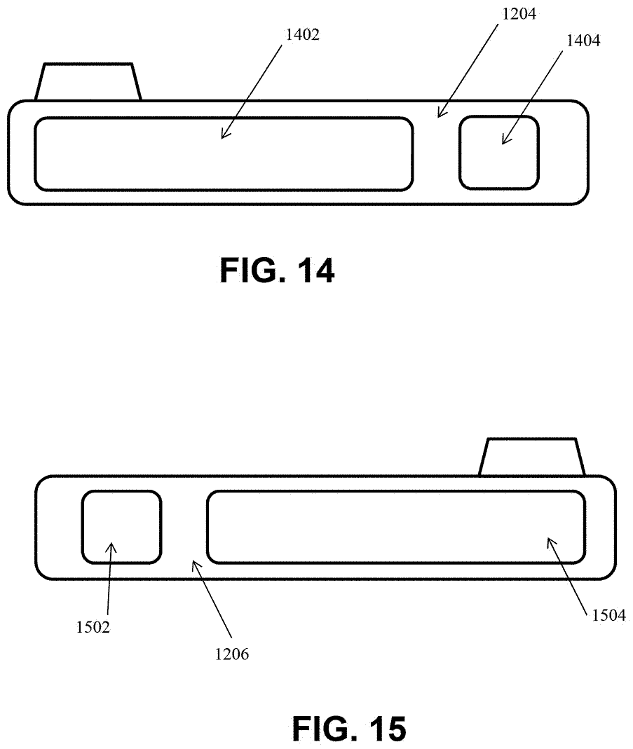

FIG. 12 shows a front view of an embodiment of the door handle 1202 that can comprise the smart-lock 108 to allow for mounting on both left-handed and right-handed doors. The door handle 1202 shown in FIG. 12 can represent the interior door handle or (not mutually exclusive) the exterior door handle of a door lock (such as an embodiment of the smart-lock 108). The door handle 1202 has two sides that look similar or identical: side A 1204 and side B 1206—either of the said two sides can be the bottom or the top of the door handle 1202 depending on whether the door handle 1202 is mounted on a left-handed or a right-handed door. FIG. 14 shows the surface of side A 1204 of the door handle 1202: whilst FIG. 15 shows the surface of side B 1206 of the door handle 1202. Side A 1204 and side B 1206 of the door handle 1202 have similar/identical features—side A 1204 includes a display 1402 and a button 1404, whilst side B 1206 also includes a display 1504 and a button 1502. Hence, either side A 1204 or side B 1206 could be mounted to be the top of the door handle 1202—the top of the door handle 1202 is the side that a user would be seeing when looking down on the door handle 1202 when it is mounted on a door. FIG. 13 shows a side view of the door handle 1202 mounted onto a door 1302. FIG. 13 shows the door handle 1202 having a front side 1208, and a back side 1304. FIG. 13 also shows side A 1204 and side B 1206 of the door handle 1202—either of which can be the top or the bottom of the door handle 1202 depending on whether the door unto which the door handle 1202 is mounted on is right-handed or left-handed.

The side of a given door handle (such as side A 1204 or side B 1206 of the door handle 1202 shown in FIG. 12) that should be active (i.e., be functional for users) when mounted can be dependent on whether the said door handle is mounted on a left-handed door or a right-handed door. A user could manually configure/select which side of a door handle (such as side A 1204 or side B 1206 of the door handle 1202) should be active. Alternatively, sensors could be used to intelligently determine and activate the most suitable side for each (interior and exterior) door handle (which would logically be the side of each door handle that is deemed to be facing the upward direction)—hence, causing one or more mode of interaction that is included on the selected side (such as a button and/or a display) to become active/operational/functional. Any visual mode of interaction (which can for example be a display or an LED indicator) that is deemed to be facing downwards could be configured to become inactive to conserve energy. Modes of interactions that can still be useful when facing downwards (such as a button) could be configured to be inactive or be configured to be functional/operational—performing the same or a different function to a button (or otherwise) that is comprising the side of the door handle 1202 that is deemed to be facing upward. Hence, a user (such as a user who is an administrator of the smart-lock 108) may be able to configure the door handle 1202 to allow users to access primary features (which can for example be features/functions that are likely to be most used—this can for example be a button (comprising the interior door handle) that is configured to manually lock and unlock the smart-lock 108) by interacting with the side of the door handle 1202 that is facing upwards. Whilst a user may be able to configure the door handle 1202 to allow for secondary features to be made available to users when interacting with the side of the door handle 1202 that is facing downwards. Secondary features can for example be features/functions that are to be used less frequently then features/functions that are accessible on the side of the door handle 1202 that is facing upwards—for example, a button (that is comprising the bottom side of the exterior door handle) could be configured to function as a button for retracting the locks of the smart-lock 108 in case of emergency.

Although the door handle 1202 shown in FIG. 12 includes a button and a display on both side A 1204 and side B 1206; it should be noted that the door handle 1202 can include different components in other embodiments depending on the desired function/functions of the door handle 1202 and/or the smart-lock 108. For example, a solar panel could be included on two sides of a door handle (such as on side A 1204 and side B 1206 of the door handle 1202) that is to be included on the exterior side 204 of the smart-lock 108. In another example, a sensor for imaging palm prints could be included on two sides of a door handle (such as on side A 1204 and side B 1206 of the door handle 1202)—with the said door handle comprising the exterior side 204 of the smart-lock 108 to allow for the imaging of users' palm prints as they attempt to turn/touch the said door handle (this is as discussed in the section of this document entitled “The biometric door handle”). Hence, any component (such as buttons, displays, LEDs and imaging sensors) can be included on a door handle (such as the door handle 1202) in a manner that would allow users to utilize desired functions on both right-handed and left-handed doors.

When comprising the interior side 202 of the smart-lock 108, a door handle (such as the door handle 1202, or the biometric door handle 802) can be understood to be the interior door handle; therefore, any device that may be comprising such door handle can be said to be comprising the interior side 202 of the smart-lock 108. Hence (as an example), any display (which can for example be the display 1402, the display 1504, and/or the display 1210) that may be included on a door handle that is comprising the interior side 202 of the smart-lock 108 can be (or can be thought of as being) the interior display 314. This means that in an embodiment of the smart-lock 108, there can be more than one interior display 314—which may display the same or different items/information. Similarly, when comprising the exterior side 204 of the smart-lock 108, a door handle (such as the door handle 1202, or the biometric door handle 802) can be understood to be the exterior door handle; therefore, any device that may be comprising such door handle can be said to be comprising the exterior side 204 of the smart-lock 108. Hence (as an example), any display (which can for example be the display 1402, the display 1504, and/or the display 1210) that may be included on a door handle that is comprising the exterior side 204 of the smart-lock 108 can be (or can be thought of as being) the exterior display 406. This means that in an embodiment of the smart-lock 108, there can be more than one exterior display 406—which may display the same or different items/information.

### Display on the Front Side of a Door Bandle

As previously discussed, the door handle 1202 can include a display on two sides (on side A 1204 and side B 1206)—such displays may be seen when a user looks at the door handle 1202 from a top view (i.e., when a user looks down at the door handle 1202). Examples of information that could be displayed/included on the door handle 1202 (i.e., on the display 1402 or the display 1504—depending on which is facing the upward direction) when comprising the interior side 202 of the smart-lock 108 include and is not limited to the lock status of the smart-lock 108—hence, by looking down at the door handle 1202 (i.e., by looking at either the display 1402 or the display 1504—depending on which is facing the upward direction), a user can acquire information such as the lock status of the smart-lock 108. Whilst examples of information that could be displayed/included on the door handle 1202 (i.e., on the display 1402 or the display 1504—depending on which is facing the upward direction) when comprising the exterior side 204 of the smart-lock 108 include and is not limited to the lock status of the smart-lock 108, the occupancy status of the room 102, an indication as to whether or not conditional access (as discussed in the section of this document entitled “Conditional access”) is active and any information relating to conditional access, an indication as to whether or not safe opening (as discussed in the section of this document entitled “Safe opening”) is active on the smart-lock 108, any “do not disturb” notification, and any information relating to the smart-lock 108 and/or any device that the smart-lock 108 may be directly or indirectly connected to.

Whereas the display 1402 and the display 1504 can be useful for displaying information (or otherwise) for users as they look down on the door handle 1202, it may be useful to include a display on the front side 1208 of the door handle 1202. In an embodiment, the door handle 1202 can include a display 1210 on its front side 1208—this is as shown in FIG. 12. A display 1210 on the front side 1208 of the door handle 1202 can potentially allow users to view information from a greater distance (and different angle) than they would be able to see on either the display 1402 or the display 1504. For example, when comprising the interior side 202 of the smart-lock 108, the display 1210 that can be included on the front side 1208 of the door handle 1202 could provide a means for a user who is inside the room 102 to be made aware (or be reassured) of the lock status of the smart-lock 108 this could be particularly useful should the room (whose door has the smart-lock 108 installed onto it) be a bathroom, a toilet or the likes. This is because a user may be able to look/glance at the display 1210 and be reassured of the lock status of the smart-lock 108 without needing to approach the smart-lock 108 to look at either the display 1402 or the display 1504.

A display 1210 included on the front side 1208 of the door handle 1202 may need to adapt to different orientations if an embodiment of the door handle 1202 or the smart-lock 108 is to allow for installing on both left-handed doors and right-handed doors. Several technologies can be used for the display 1210 that can be included on the front side 1208 of the door handle 1202, examples include and is not limited to segment displays (such as an LCD segment display, an LED segment display, or an E-Ink segment display) and displays having pixels (such as an LED display, an LCD display, an E-ink display, or a dot matrix display). Pixel based displays can likely easily adapt to display information in different orientations (i.e., when such display is rotated). However, should a segment display be included on the front side of a door handle (such as the front side 1208 of the door handle 1202) that is designed for mounting on both left-handed doors and right-handed doors, then designs considerations can be advised to allow the said segment display to be suitable for use on both left-handed and right-handed doors, t may therefore be useful for a segment display that is to be included on the front side 1208 of the door handle 1202 to be designed for use at a standard orientation as well as upside down (i.e., when rotated 180 degrees)—this is for when a given door handle (such as the door handle 1202) is to be designed to be mountable on both left-handed and right-handed doors.

### Examples of Two Displays for the Front Side of a Door Handle

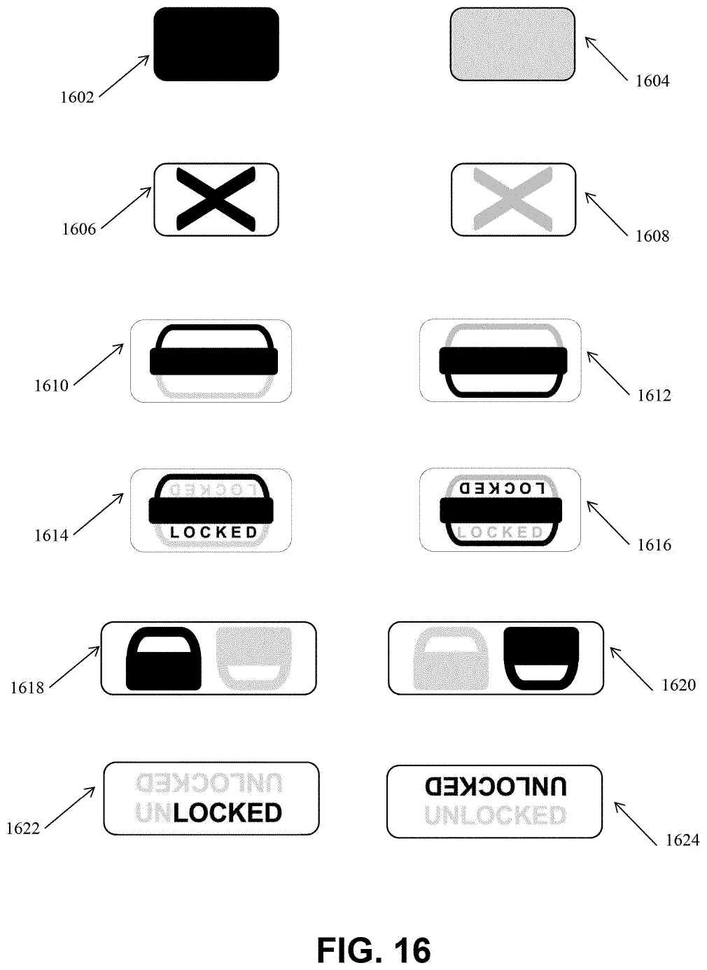

FIG. 16 shows different embodiments of segment displays that could be used for the display 1210 which can be included on the front side 1208 of the door handle 1202—these are examples of designs for segment displays and are not exhaustive. In an embodiment of the smart-lock 108, such displays (as shown in FIG. 16) could for example be used on the interior side 202 of the smart-lock 108 (i.e., on the interior door handle) to reassure any user who is inside the room 102 of the lock status of the smart-lock 108—they can however also be useful on the exterior side 204 of the smart-lock 108 (i.e., they can be included on the exterior door handle). The segment displays shown in FIG. 16 are designed to be used on both left-handed doors and right-handed doors hence, the said displays are designed to be used at a standard orientation as well as when rotated 180 degrees. The segment display with which each segment display in FIG. 16 is said to be paired with indicates that they are the same display showing different segments with faint lines used to indicate that a segment is off and solid/black lines used to indicate that a segment is on.

In an embodiment, the display 1210 that can comprise the front side 1208 of the door handle 1202 can be configured to indicate (on the interior door handle) when the lock status of the smart-lock 108 is “unlocked” (i.e., when the locks of the smart-lock 108 are retracted) and when the lock status of the smart-lock 108 is “locked”. This could be a means of reassuring any user who may be inside the room 102 of the lock status of the smart-lock 108.

Segment display 1602 is paired with segment display 1604 (i.e., this is the same display showing different segments)—segment display 1602 could for example be used to indicate that the lock status of the smart-lock 108 is “locked”, whilst segment display 1604 (showing a blank screen) could be used to indicate that the locks of the smart-lock 108 are not applied (i.e., to indicate that the lock status of the smart-lock 108 is “unlocked”). Similarly, segment display 1606 is paired with segment display 1608 (i.e., this is the same display showing different segments)—with the cross (shown on segment display 1606) being used to indicate that the lock status of the smart-lock 108 is “locked” and a blank screen (i.e., all segments being off) being used to indicate that the lock status of the smart-lock 108 is “unlocked” (this is as shown on segment display 1608).

Segment display 1610 is paired with segment display 1612 (i.e., this is the same display showing different segments). In one orientation, segment display 1610 could be used to indicate that the lock status of the smart-lock 108 is “locked” (by displaying a padlock icon), whilst the image in segment display 1612 can be used to indicate that the smart-lock 108 is locked in another orientation (i.e., should the door handle 1202 be rotated 180 degrees). A blank screen could be displayed (with all segments on the display being turned off) to indicate when the lock status of the smart-lock 108 is “unlocked”. Segment display 1614 is paired with segment display 1616 (i.e., this is the same display showing different segments). Segment display 1614 and segment display 1616 are similar to segment display 1610 and segment display 1612 except that the word “LOCKED” is included on both the standard orientation (i.e., segment display 1614) and the rotated orientation (i.e., segment display 1616).

Segment display 1618 is paired with segment display 1620 (i.e., this is the same display showing different segments)—a padlock icon can be displayed in either orientation to indicate when the lock status of the smart-lock 108 is “locked”; whilst a blank screen could be used to indicate that the locks of the smart-lock 108 are not applied. Segment display 1622 is paired with segment display 1624 —hence, this is the same display showing different segments of a four-segment display. With each orientation being able to display the word “LOCKED” and the word “UNLOCKED” to indicate when the lock status of the smart-lock 108 is “locked” or “unlocked”. A blank screen could also be used to show when the lock status of the smart-lock 108 is “unlocked”.

### Detecting Touch on a Door Handle

As discussed in the section of this document entitled “Reducing the likelihood of incorrectly assessing the occupancy status of a room”, the smart-lock 108 can include a means of detecting whether the door 104 of the room 102 is open or closed. Alternatively (or additionally), a device (such as the door monitoring device) can be configured to monitor the door unto which the smart-lock 108 is installed/fitted and in-turn communicate information (such as when the said door is opened and closed) to the smart-lock 108 which would result in the smart-lock 108 being aware of whether the door unto which it is installed/fitted is opened or closed. This section of the document entitled “Detecting touch on a door handle” discusses an embodiment of the smart-lock 108 that includes door handles. As previously discussed, when comprising the interior side 202 of the smart-lock 108, a door handle can be understood to be the “interior door handle”. Similarly, when comprising the exterior side 204 of the smart-lock 108, a door handle can be understood to be the “exterior door handle”. It should be noted that discussions, statements, and examples regarding door handles on the smart-lock 108 can also apply to doorknobs as some embodiments of the smart-lock 108 can comprise doorknobs in lieu of door handles. Hence, discussions, statements, and examples made regarding the interior door handle (i.e., a door handle that can be included on the interior side 202 of the smart-lock 108) can also be understood to apply to an interior doorknob (i.e., a doorknob that can be included on the interior side 202 of the smart-lock 108)—this means that an embodiment of the smart-lock 108 can include an interior doorknob that is able to detect when it is touched (which can aid the smart-lock 108 in assessing whether the room whose door it is installed/fitted onto has a presence inside it).

In an embodiment, the smart-lock 108 can comprise a means of detecting when its interior door handle is touched. This ability to detect a touch can be for the entire surface of the interior door handle (i.e., parts that a user may touch whilst the handle is mounted) or for one or more part/side of the interior door handle. An embodiment of the smart-lock 108 comprising a means of detecting when the interior door handle is touched, as well as a means of detecting (or acquiring information (from any capable device that the smart-lock 108 may be connected to, such as, for example, the door monitoring device) regarding) whether the door unto which it (i.e., the smart-lock 108) is installed/fitted on is open or closed can be capable of estimating/gauging whether there is a presence inside the room whose door has the smart-lock 108 installed/fitted unto it. This is because whilst the door of a room (such as the door 104 of the room 102) is closed, a touch of the interior door handle can indicate that the said room has a presence inside it.

An embodiment of the smart-lock 108 having a means of detecting when the interior door handle is touched can be useful in establishing (or detecting) when there is a presence inside the room 102. This could be in addition or in lieu of other means (such as, for example, the interior PIR sensor 304) of detecting a presence inside the room 102. Should an embodiment of smart-lock 108 have no other means of detecting a presence inside the room 102 (apart from a means of detecting when the interior door handle has been touched)—then, detecting when the interior door handle has been (or is being) touched (whilst the door 104 is deemed closed) could be sufficient to conclude that there is a presence inside the room 102. Detecting when the interior door handle of the smart-lock 108 is touched could also aid the smart-lock 108 in deciding when to automatically apply its locks. The smart-lock 108 could be configured to automatically apply its locks (and/or perform other actions) upon detecting that its interior door handle has been touched whilst the door 104 of the room 102 is deemed closed.

In an embodiment of the smart-lock 108, the ability to detect a touch on the interior door handle can also be used together with one or more other means of detecting a presence inside the room 102 to better evaluate/assess/derive the occupancy status of the room 102. This could in-turn enable the smart-lock 108 to better decide when to automatically apply its locks. Examples of such other means of detecting a presence inside the room 102 include and is not limited to having a presence detection sensor (such as, for example, a PIR sensor, a RADAR, sensor, or an ultrasonic sensor) comprise the interior side 202 of the smart-lock 108 or having the smart-lock 108 acquire data regarding any presence that may be detected inside the room 102 from another device (such as, for example, a PIR sensor device, or a door monitoring device) that it may be connected to.

Should the door unto which the smart-lock 108 is installed/fitted become closed (i.e., go from being open to being closed) without any touch being detected on the interior door handle (following the moment that the said door has become closed), then there may not be enough evidence to assume/deem that there is a presence inside the said room (unless the smart-lock 108 has detected or can detect a presence (inside the said room) through another means)—the smart-lock 108 could be configured to assume that the said room is vacant in such case. Hence, the smart-lock 108 could be configured to ensure that its locks are retracted (which may mean the smart-lock 108 retracting its locks (if they were applied) should it not be able to establish that there is a presence inside the room 102 once the door 104 of the room 102 closes—this could for example be useful should the room 102 be a toilet/bathroom (in a bid to ensure that said room is not erroneously left locked whilst vacant). In an embodiment, the smart-lock 108 can be configured to express its lock status on its interior side 202 (be it on a display (such as, for example, on the interior display 314), using on or more LED indicator, or by any other visual and/or audio means) upon it detecting a touch on its interior side 202 (such as on its interior door handle). Alternatively (or additionally), a press of a button (which can be included on the interior side 202 of the smart-lock 108) could be employed—whereby the smart-lock 108 could be configured such that the pressing of the said button would result in the smart-lock 108 expressing (visually and/or audibly) its lock status on its interior side 202.

Similarly, in an embodiment, the smart-lock 108 can be configured to express its lock status (and/or the occupancy status of the room 102) on its exterior side 204 (be it on a display (such as, for example, on the exterior display 406), using one or more LED indicator, or by any other visual and/or audio means) upon it detecting a touch on its exterior side 204 (such as on its exterior door handle); this is a form of virtual knock—hence, in an embodiment, the smart-lock 108 can include a means of detecting when its exterior door handle has been (or is being) touched. Alternatively (or additionally), a press of a button (which can be included on the exterior side 204 of the smart-lock 108) could be employed—whereby the smart-lock 108 could be configured such that the pressing of the said button would result in the smart-lock 108 expressing (visually and/or audibly) its lock status and/or the occupancy status of the room 102 on its exterior side 204. Capacitive sensing is an example of a technology that can be used to detect touches—it can therefore comprise the smart-lock 108 for the purpose of detecting when its interior door handle (and/or any part of the smart-lock 108) has been (or is being) touched. It should be noted that any suitable technology may be used to detect when the interior door handle (and/or any part of the smart-lock 108) has been (or is being) touched.

### Usage in Temporary Accommodations

This section of this document entitled “Usage in temporary accommodations” discusses several useful features that can be included on the smart-lock 108 and be advantageous in places of temporary accommodation. Although many of the features and methods discussed in this section of this are geared towards settings of temporary accommodation, it should be noted that all such features can also be useful and can hence be included on the smart-lock 108 in a non-temporary setting (such as a house, a residential home, and an office environment/place of work). As well as domestic settings (such as flats, and houses)—the smart-lock 109 can also be advantageous in settings of temporary habitation. Examples of such settings includes and is not limited to hotels, motels, bed and breakfast locations. Airbnb (TM of Airbnb, Inc.) locations, and the likes. The smart-lock 108 can be configured to connect to a managements system (such as a hotel management system) to allow easy/centralized management of the smart-lock 108 in such settings.

Should the smart-lock 108 be installed on the door of a place of temporary accommodation (such as the door of a hotel room); it may be beneficial for information that can be useful to users (such as guests and service users) and stakeholders (such as hotel managers) of the setting to be displayed on the exterior side 204 of the smart-lock 108 (on for example (and not limited to) the exterior display 406). Examples of information that the smart-lock 108 could be configured to display on its exterior side 204 includes and is not limited to displaying a do not disturb notice, displaying if an occupant wishes their room to be cleaned, and displaying the time of the next check-in. Similarly, it may be beneficial for information that can be useful to users (such as guests and service users) and stakeholders (such as hotel managers) of the setting to be displayed on the interior side 202 of the smart-lock 108 (on for example (and not limited to) the interior display 314). Examples of information that the smart-lock 108 could be configured to display on its interior side 202 includes and is not limited to displaying the check-out time for the occupant, displaying messages, displaying reminders, displaying the temperature of the room 102, displaying the humidity level of the room 102, displaying the time, and displaying information regarding the weather.

In an embodiment, the smart-lock 108 can be configured to acquire network credentials (such as WIFI credentials) from a management system that it is connected to. The smart-lock 108 could have a client-host relationship with such management system—whereby the host (being the management system) would generate and/or communicate network credentials to the smart-lock 108 (being the client), Examples of such management system includes and is not limited to a hotel management system, or a WIFI router that can generate and/or assign WIFI credentials. A hotel management system could for example be configured to allocate WIFI credentials to service users which can be delivered/communicated through the smart-lock 108 fitted on the door of each room in the setting. Network credentials could be allocated on different basis, such as per room (whereby each booked room in the setting is allocated unique network credentials) or general credentials may be issued that may not be unique to each room (general credentials may for example be credentials that are subject to change periodically). Once, the smart-lock 108 receives/acquires network credentials from a management system it can than communicate them to other devices or display the network credentials on its interior side 202 (on for example (and not limited to) the interior display 314 (this could for example be expressed as a WIFI QR code) for users to see. Alternatively, a WPS button (or similar) could be included on the interior side 202 of the smart-lock 108 to allow guests easy access to a network (such as the Wi-Fi network of a hotel).

Although particular embodiments of the inventions (such as features, methods, processes, devices, and systems) disclosed in this document have been described in detail for purposes of illustration, various modifications and enhancements can be made without departing from the spirit and scope of the inventions and innovations disclosed in this document.

1. A smart-lock system for securing a room, the smart-lock system comprising:
a smart-lock installed on a door of the room, the smart-lock comprising:
at least one power source;
at least one memory;
an interior portion and an exterior portion, the interior portion configured to be removably fixed to the interior portion of the door and the exterior portion configured to be removably fixed to the exterior portion of the door;
one or more interior sensors disposed on the interior portion for acquiring at least one of:
a radar information, an audio information, and/or infrared information, from a surrounding environment of the interior portion;
one or more exterior sensors disposed on the exterior portion for acquiring at least one of: a radar information, an audio information, and/or infrared information from a surrounding environment of the exterior portion;
one or more closure sensors disposed on the door and configured to acquire information used to determine whether the door is in an opened or closed position;
a processor, communicatively coupled with the at least one memory, the one or more interior sensors, the one or more exterior sensors, and the one or more closure sensors;
wherein the processor is configured to receive information from the one or more inside sensors, the one or more outside sensors, and the one or more closure sensors; and
the memory comprising programmed instructions that, when executed, cause the processor to:
determine a closure status of the door based on information received by the processor from the one or more closure sensors;
determine an occupancy status of the room based on the closure status of the door and information received by the processor from the one or more interior sensors and the one or more exterior sensors.

2. The smart-lock system of claim 1, further comprising:
a locking mechanism;
an actuator communicatively coupled to the processor and configured to actuate the lock mechanism to secure and/or to release the lock mechanism; and
wherein the programmed instructions, when executed, further cause the processor to:
automatically secure the locking mechanism in response to determining that the door is closed and the room is occupied.

3. The smart-lock system of claim 2, further comprising an emergency button disposed on the exterior portion and configured to release the lock mechanism upon being pressed.

4. The smart-lock system of claim 2, further comprising:
one or more interior handle sensors disposed on the interior portion and configured to acquire information used to determine if the interior handle of the door has been engaged;
one or more exterior handle sensors disposed on the exterior portion and configured to acquire information used to determine if the exterior handle of the door has been engaged or touched;
wherein the one or more interior and exterior handle sensors are communicatively coupled to the processor;
wherein the programmed instructions, when executed, further cause the processor to: determine an interior handle engagement status of the internal handle based on information received by the processor from the one or more interior handle sensors;
determine an exterior handle engagement status of the external handle based on information received by the processor from the one or more exterior handle sensors; and
wherein the interior handle engagement status is considered by the processor when determining the occupancy status of the room in order to reduce the likelihood of the system incorrectly concluding that the room is occupied if engagement of the interior handle results in a determination that the room is occupied based on information from the one or more interior sensors affected by the engagement of the interior door handle.

5. The smart-lock system of claim 4, wherein the smart-lock system further comprises:
an interior display and speaker disposed on the interior portion of the door and configured to visually and/or audibly provide notification regarding the lock status of the door;
an exterior display and speaker disposed on the exterior portion of the door and configured to visually and/or audibly provide notification regarding the occupancy status of the room; and
wherein the interior and exterior displays are communicatively coupled to the smart-lock.

6. The smart-lock system of claim 5, wherein the smart-lock system further comprises a do-not-disturb button disposed on the interior portion and configured to toggle, on the exterior display, the visual display of characters, symbols, images, and/or colors used to indicate that the user inside the room does not wish to be disturbed.

7. The smart-lock system of claim 5, wherein the programmed instructions, when executed, further cause the processor to, in response to determining that a person is within close proximity of the exterior portion, using the exterior display and/or speaker, visually and/or audibly provide information regarding the occupancy of the room and lock status of the door to the person.

8. The smart-lock system of claim 7, wherein the programmed instructions, when executed, further cause the processor to, in response to determining that the person is within close proximity of the exterior portion, using the interior display and/or speaker, visually and/or audibly provide information regarding the presence of the person to the user within the room.

9. The smart-lock system of claim 8, wherein the smart-lock system further comprises:
a network module configured to communicatively couple the smart-lock system to at least one wireless device and/or server using a local area network;
wherein the at least one wireless device has speakers and is configured to be queryable by a user for room occupancy and/or door locking information; and
wherein the at least one wireless device is configured to audibly alert nearby persons that a room is no longer occupied if a user requests this service.

10. The smart-lock system of claim 9, wherein the at least one wireless device includes one or more lights configured to automatically turn on when the room is determined to be occupied, and to automatically turn off when the room is determined to be unoccupied.

11. The smart-lock system of claim 10, wherein the smart-lock system further comprises a wireless remote having a display and communicatively coupled to the smart-lock, the wireless remote is configured to display the lock status of the door, remotely secure and/or to release the lock mechanism, adjust the brightness of the one or more lights, and send information relating to the presence of a user within the room when the wireless remote is utilized.

12. The smart-lock system of claim 2, wherein the at least one memory further stores a safe opening challenge based on the user profile and user profile information, the user profile information including a measurement of the height of the user; and
wherein users can be determined to be exempt from the safe opening challenge depending on their user profile information.

13. The smart-lock system of claim 2, wherein the remote device further comprises a smart device communicatively coupled with the smart-lock system and configured to detect when the user is in distress, and wherein upon the smart device detecting that the user is in distress, the smart-lock system is configured to release the lock mechanism.

14. The smart-lock system of claim 2, wherein the one or more interior sensors include at least one sensor configured to measure a level of luminance of the surrounding environment of the interior portion and wherein the one or more exterior sensors include at least one sensor configured to measure a level of luminance of the surrounding environment of the exterior portion.

15. The smart-lock system of claim 14, wherein the one or more interior sensors include at least one sensor configured to detect a presence of a user within the room and wherein the one or more exterior sensors include at least one sensor configured to detect a presence of a user outside of the room.

16. The smart-lock system of claim 2, wherein the interior and exterior displays are further configured to display a user interface that facilitates an administrator's customization of device settings including:
creating and/or amending one or more conditional access rules, wherein when creating or amending a conditional access rule, an administrator can:
specify one or more conditions under which the user(s) should be granted a particular type of access (such as instant access, delayed access, or denied access),
specify exceptions under which the user(s) should be granted an alternative type of access if certain conditions are met, and
enabling, disabling, and/or deleting existing one or more conditional rules.

17. The smart-lock system of claim 16, further comprising:
a biometric door handle having one or more sensors that enable biometric recognition, the biometric door handle being disposed on the exterior portion of the door and communicatively coupled to the smart-lock
a biometric module configured to determine the identity of the user based on one or more sensors of the biometric door handle and, based on the determined user identity and administrator set conditional access rules, to:
grant the user instant access by releasing the lock mechanism,
grant the user delayed access by releasing the lock mechanism after a predefined period of time has passed, or to
deny the user access by not releasing the lock mechanism.

18. A method of operating a smart-lock system, comprising;
installing a smart-lock on a door of a room, the smart-lock comprising:
at least one power source;
at least one memory;
an interior portion and an exterior portion, the interior portion configured to be removably fixed to the interior portion of a door and the exterior portion configured to be removably fixed to the exterior portion of the door;
one or more interior sensors disposed on the interior portion for acquiring at least one of: a radar information, an audio information, and/or infrared information, from a surrounding environment of the interior portion;
one or more exterior sensors disposed on the exterior portion for acquiring at least one of: a radar information, an audio information, and/or infrared information from a surrounding environment of the exterior portion;
one or more closure sensors disposed on the door and configured to acquire information used to determine whether the door is in an opened or closed position;
one or more interior handle sensors disposed on the interior portion and configured to acquire information used to determine if the interior handle of the door has been engaged by the user;
one or more exterior handle sensors disposed on the exterior portion and configured to acquire information used to determine if the exterior handle of the door has been engaged by the user;
an interior display and speaker disposed on the interior portion of the door and configured to visually and/or audibly provide notification regarding the lock status of the door; and
an exterior display and speaker disposed on the exterior portion of the door and configured to visually and/or audibly provide notification regarding the occupancy status of the closure,
a processor, communicatively coupled with the at least one memory, the one or more interior sensors, the one or more exterior sensors, the one or more closure sensors, the one or more interior handle sensors, the one or more exterior handle sensors, the interior display and speakers, and the exterior display and speakers;
determining, by the smart-lock, a closure status of the door, wherein the closure status can be an open status or a closed status;
determining, by the smart lock, an occupancy status of the room, wherein the occupancy status can be an occupied status or an unoccupied status.

19. The method of claim 18, further comprising the step of:
determining whether a person is within close proximity of the exterior portion; and
in response to determining that a person is within close proximity of the exterior portion;
visually and/or audibly providing information regarding the occupancy of the room and the lock status of the door to the person proximity to the exterior portion.

20. The method of claim 19, further comprising the step of:
in response to determining that the person is within close proximity of the exterior portion;
visually and/or audibly providing information regarding the presence of the person's proximity to the exterior portion to the user within the room using the internal display and speaker.

21. The method of claim 19, wherein the smart-lock further comprises:
a communication device configured to communicate and facilitate an exchange of data with at least one remote device;
a memory unit storing one or more user profiles, each user profile including a safe opening challenge based on the user profile, biometric characteristics of respective users, data of a user device associated with the respective user, non-biometric characteristics of the respective user, the smart-lock further comprising a biometric sensor configured to detect user biometrics and communicate with the smart-lock system, the user profile including the height of the user,
a speaker device to communicate with a user;
a do not disturb button to enable and disable a do not disturb mode;
a microphone device configured to record sound data of an area proximate to the door, the sound data including voice commands of the user; and
one or more motion sensors including an ultrasonic sensor and an accelerometer, the motion sensor being configured to detect motion of the user in the room.

22. The method of claim 20, wherein the smart-lock further comprises:
a wireless remote in communication with the smart-lock via the communication device, the wireless remote including a display, a speaker device, and one or more buttons;
a door closure monitoring device in communication with the smart-lock; and
a smart device including a smart watch configured to detect when the user is in distress.

23. The method of claim 21, further comprising the steps of:
determining, by the smart-lock, the occupancy status of the room based on at least one sound data and/or motion data;
displaying, using the interior and exterior displays, the lock status and the occupancy status of the room; and,
providing, using the smart-lock, notification regarding the occupancy status of the room and lock status of the room, the notification is provided by at least one of the speaker device, the display device, a smart doorbell button, or remote device.

24. The method of claim 22, further comprising the steps of:
enabling wireless control, by the wireless remote, of the smart-lock;
detecting, by the door handle and the smart-lock, an individual's attempt to open the door and providing notification regarding the occupancy status of the room and lock status of the door to the individual, and
unlocking, using the smart-lock, the door when the user is in distress.

25. The method of claim 23, further comprising the step of:
providing, using the smart-lock, the safe opening challenge to the user, wherein one or more users are exempt from the safe opening challenge if the user profile matches the profile stored in the safe opening challenge, which includes measuring the height of the user to determine the identity of the user,
provide an access type based on one or more factors, the factors comprise identity of the user, occupancy status of the room, data and time of access of the room, the do not disturb mode, biometrics characteristics of the user and the non-biometrics characteristics of the user, the access type includes a denied access, an instant access and a delayed access;
determining, using the smart-lock, the identity of the user; and
performing at least one function depending upon the identity of the user, the classification of users including an authorized user and an unauthorized user, wherein the function includes unlocking the door when the occupancy status is unoccupied, locking the door when the occupancy status is occupied, provide notification regarding the occupancy status of the room and lock status of the room.

26. The method of claim 20, further comprising the steps of:
connecting the smart-lock to a management system of a temporary accommodation room;
displaying, at the exterior portion of the temporary accommodation room, one or more status including, do not disturb notice, requirement of room cleaning, and the time of the next check-in, and
displaying, at the interior portion of the temporary accommodation room, check-out time for the occupant, messages, reminders, the temperature of the room, the humidity level of the room, the time, and information regarding the weather.

27. A door monitoring device comprising:
a housing configured to be removably fixed to a door or a location proximate to the door;
at least one power source;
at least one memory;
one or more sensors disposed on or within the housing for acquiring at least one of: a radar information, an infrared information, a physical distance information, a movement information, and/or an audio information from a surrounding environment of the housing;
a processor, communicatively coupled with the at least one memory, the one or more sensors;
wherein the processor is configured to receive information from the one or more sensors; and;
the memory comprising programmed instructions that, when executed, cause the processor to:
determine a closure status of the door based on information received by the processor from the one or more sensors;
determine an occupancy status of the room based on the closure status of the door and information received by the processor from the one or more sensors.

28. The door monitoring device of claim 27, wherein the door monitoring device further comprises:
a communication device configured to communicate and facilitate an exchange of data with at least one remote device, wherein the door monitoring device can utilize the communication device to control the at least one remote device; and
wherein the door monitoring device can be configured to automate tasks such as activating a remote device based on the determined occupancy status of the room.
